(19) United States
(12) Patent Application Publication
(10) Pub. No.: US 2024/0086714 A1
(43) Pub. Date: Mar. 14, 2024

(54) INFORMATION PROCESSING APPARATUS AND INFORMATION PROCESSING METHOD

(71) Applicant: SONY GROUP CORPORATION, TOKYO (JP)

(72) Inventor: TOMOYA KIMURA, TOKYO (JP)

(21) Appl. No.: 17/754,699

(22) PCT Filed: Jul. 14, 2020
(86) PCT No.: PCT/JP2020/027416

§ 371 Date: Apr. 8, 2022

(30) Foreign Application Priority Data
Oct. 18, 2019 (JP) 2019-191244

(51) Int. Cl. G06N 3/092

(52) U.S. Cl. CPC G06N 3/092

(57) ABSTRACT

An information processing apparatus (100) includes: an acquisition unit (153) that acquires a machine learning model trained with reinforcement learning such that, when first state information indicating a first state has been input, the model will output first action information indicating a first action corresponding to the first state, based on a plurality of rewards weighted by a weight of each of the rewards; a reception unit (151) that receives training data being a set of second state information indicating a second state and second action information indicating a second action corresponding to the second state; and a display unit (156) that displays information regarding the weight of each of the rewards estimated by training the machine learning model in which the weight of each of the rewards is defined as a part of a connection coefficient of the machine learning model such that, when the second state information included in the training data and a value based on the weight of each of the rewards have been input, the model will output the second action information included in the training data.

### FIELD

The present disclosure relates to an information processing apparatus and an information processing method.

### BACKGROUND

In recent years, various technologies utilizing machine learning have been developed. For example, technologies for improving performance and efficiency of reinforcement learning have been actively studied. For example, there is a disclosed technology of receiving an input of a value regarding a level of importance to be placed on a reward regarding a calculation time in reinforcement learning and controlling a behavior of a machine learning model according to the received input value.

### CITATION LIST

### Non Patent Literature

Non Patent Literature 1: Augustus Odena, Dieterich Lawson, Christopher Olah, “CHANGING MODEL BEHAVIOR AT TEST-TIME USING REINFORCEMENT LEARNING”, Feb. 24, 2017, [Online], [searched on Sep. 12, 2019], Internet <URL: https://arxiv.org/abs/1702.07780>

### SUMMARY

### Technical Problem

With the above-described known technology, however, it is not always possible to support the use of the machine learning model trained with reinforcement learning. For example, the above-described known technology has a limitation in that it just receives input of a value regarding the level of importance to be placed on a reward regarding a calculation time in reinforcement learning and just controls the behavior of a machine learning model according to the received input value, and this not always ensure possibility to support use of the machine learning model trained with reinforcement learning.

In view of this, the present disclosure proposes an information processing apparatus and an information processing method capable of supporting use of a machine learning model trained with reinforcement learning.

### Solution to Problem

To solve the above problem, an information processing apparatus comprising:
an acquisition unit that acquires a machine learning model trained with reinforcement learning such that, when first state information indicating a first state has been input, the model will output first action information indicating a first action corresponding to the first state, based on a plurality of rewards weighted by a weight of each of the rewards;
a reception unit that receives training data being a set of second state information indicating a second state and second action information indicating a second action corresponding to the second state; and
a display unit that displays information regarding the weight of each of the rewards estimated by training the machine learning model in which the weight of each of the rewards is defined as a part of a connection coefficient of the machine learning model such that, when the second state information included in the training data and a value based on the weight of each of the rewards have been input, the model will output the second action information included in the training data.

### BRIEF DESCRIPTION OF DRAWINGS

FIG. 1 is a diagram illustrating an example of information processing according to an embodiment of the present disclosure.

FIG. 2 is a diagram illustrating an example of learning processing according to the embodiment of the present disclosure.

FIG. 3 is a diagram illustrating a configuration example of an information processing apparatus according to the embodiment of the present disclosure.

FIG. 4 is a diagram illustrating an example of a reward information storage unit according to the embodiment of the present disclosure.

FIG. 5 is a diagram illustrating an example of a training data storage unit according to the embodiment of the present disclosure.

FIG. 6 is a diagram illustrating an example of a model information storage unit according to the embodiment of the present disclosure.

FIG. 7 is a flowchart illustrating a procedure of information processing according to the embodiment of the present disclosure.

FIG. 8 is a view illustrating an example of a UI screen according to the embodiment of the present disclosure.

FIG. 9 is a view illustrating an example of the UI screen according to the embodiment of the present disclosure.

FIG. 10 is a view illustrating an example of the UI screen according to the embodiment of the present disclosure.

FIG. 11 is a view illustrating an example of the UI screen according to the embodiment of the present disclosure.

FIG. 12 is a view illustrating an example of the UI screen according to the embodiment of the present disclosure.

FIG. 13 is a view illustrating an example of the UI screen according to the embodiment of the present disclosure.

FIG. 14 is a view illustrating an example of the UI screen according to the embodiment of the present disclosure.

FIG. 15 is a view illustrating an example of the UI screen according to the embodiment of the present disclosure.

FIG. 16 is a view illustrating an example of the UI screen according to the embodiment of the present disclosure.

FIG. 17 is a view illustrating an example of the UI screen according to the embodiment of the present disclosure.

FIG. 18 is a view illustrating an example of the UI screen according to the embodiment of the present disclosure.

FIG. 19 is a view illustrating an example of the UI screen according to the embodiment of the present disclosure.

FIG. 20 is a view illustrating an example of the UI screen according to the embodiment of the present disclosure.

FIG. 21 is a view illustrating an example of the UI screen according to the embodiment of the present disclosure.

FIG. 22 is a hardware configuration diagram illustrating an example of a computer that actualizes functions of the information processing apparatus.

### DESCRIPTION OF EMBODIMENTS

Embodiments of the present disclosure will be described below in detail with reference to the drawings. In each of the following embodiments, the same parts are denoted by the same reference numerals, and a repetitive description thereof will be omitted.

The present disclosure will be described in the following order.
1. Embodiments
1-1. Overview of information processing according to embodiment
1-2. Configuration of information processing system according to embodiment
1-3. Configuration of information processing apparatus according to embodiment
1-4. Procedure of information processing according to embodiment
1-5. Example of UI screen according to embodiment
1-5-1. Example of UI screen according to embodiment
1-5-2. Example of UI screen according to embodiment
1-5-3. Example of UI screen according to embodiment
1-5-4. Example of UI screen according to embodiment
1-5-5. Example of UI screen according to embodiment
1-5-6. Example of UI screen according to embodiment
1-5-7. Example of UI screen according to embodiment
1-5-8. Example of UI screen according to embodiment
1-5-9. Example of UI screen according to embodiment
1-5-10. Example of UI screen according to embodiment
1-5-11. Example of UI screen according to embodiment
1-5-12. Example of UI screen according to embodiment
1-5-13. Example of UI screen according to embodiment
1-5-14. Example of UI screen according to embodiment
2. Other embodiments
2-1. Display of axes
2-2. Changing reward
2-3. Clustering
2-4. Other application examples
3. Effects according to present disclosure
4. Hardware configuration

### 1. Embodiments

### 1-1. Overview of Information Processing According to Embodiment

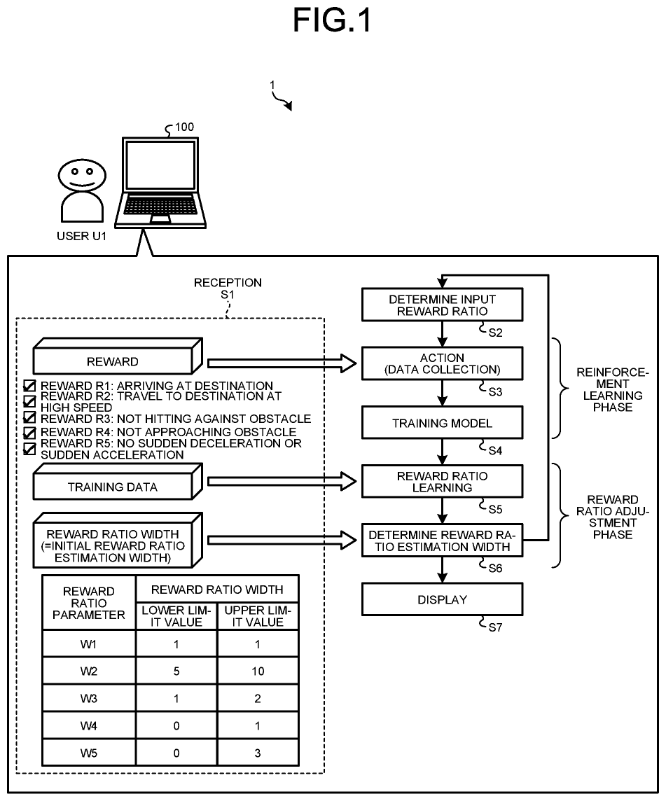

First, an overview of information processing according to an embodiment of the present disclosure will be described with reference to FIG. 1. FIG. 1 is a diagram illustrating an example of information processing according to the embodiment of the present disclosure. In the example illustrated in FIG. 1, an information processing apparatus 100 provides a user U1 with a user interface (hereinafter, also referred to as UI) that enables support of designing of a machine learning model trained with reinforcement learning.

Conventionally, reinforcement learning has been used to control the action of a robot. Specifically, there is a known technique of using the reinforcement learning to train a machine learning model that controls a robot that performs autonomous driving of a vehicle. In the example illustrated in FIG. 1, the information processing apparatus 100 uses reinforcement learning to train a machine learning model such that, when an image including a view ahead of a vehicle has been input as a state, the model will output a driving operation (operation with steering wheel, accelerator, brake, and the like) of the vehicle corresponding to the view ahead of the vehicle as an action to be taken by an agent.

Meanwhile, in the reinforcement learning, the action of the agent is optimized to maximize the reward obtained from an environment. In such optimization, the agent repeatedly performs a large number of attempts. For example, the agent performs learning by collecting a large amount of learning data independently using a simulator or the like. Therefore, in the reinforcement learning, there is an advantage that it is not necessary to prepare training data and labels which are necessary in the supervised learning.

Instead of using a label, reinforcement learning sets a reward as an index of learning. Here, in the reinforcement learning, since there is no direct connection between the set reward and the action to be learned, there is a disadvantage that it is difficult to know how the robot will actually behave until the learning is completed. For example, in a game of shooting while going around a circle course by a boat, it is assumed that a reward for shooting is given in addition to a reward for going around the course. At this time, it is assumed that the designer of the machine learning model has expected that the robot would go around the course at the same time while shooting. However, in practice, there is a possibility that the robot learns an action of repeating only shooting while circling in one place and not going around the circle course at all. In this manner, the reinforcement learning is not always possible to cause the robot to learn behavior as intended by the designer.

On the other hand, a method referred to as behavior cloning is known as a method for causing a robot to learn behavior as intended by the designer. In the behavior cloning, the designer prepares training data that is a set of a state of an environment and a behavior corresponding to the state, and the machine learning model is trained by supervised learning such that, when a state has been input, the model will output a behavior corresponding to the state. The behavior cloning has an advantage that it is possible to cause the robot to learn an action so as to behave similarly to training data provided by the designer. The behavior cloning, however, has a disadvantage that it is necessary to prepare a large amount of training data.

In view of these, the information processing apparatus 100 according to the embodiment of the present disclosure uses the reinforcement learning to train a machine learning model while automatically adjusting a weight of the reward based on training data (in small amount) prepared by the designer. The information processing apparatus 100 adjusts the weight of the reward by alternating reinforcement learning and supervised learning based on training data (in small amount). With this configuration, the information processing apparatus 100 can cause the robot to learn an action intended by the designer based on training data (in small amount). Note that the training data (in small amount) means a relatively small amount of training data as compared with the amount of training data used in learning that uses general behavior cloning.

Return to the description of FIG. 1. In the example illustrated in FIG. 1, the information processing apparatus 100 receives a plurality of rewards Rn (n=1 to 5), training data (in small amount), and a range of a weight wₙ (n=1 to 5) of each of the rewards Rn (n=1 to 5) from the user U1 being the designer of the machine learning model (step S1). Hereinafter, the weight of each of rewards may be referred to as a reward ratio (parameter), and the range of the weight of each of rewards may be referred to as a reward ratio width.

For example, the information processing apparatus 100 displays a list of rewards on a screen. For example, the information processing apparatus 100 selectively displays a plurality of rewards. For example, the information processing apparatus 100 receives a plurality of rewards Rn (n=1 to 5) selected by the user U1. Here, the reward R1 is a reward for arriving at the destination, and the reward R2 is a reward for traveling to the destination at a high speed. In addition, the reward R3 is a reward for not hitting against an obstacle, and the reward R4 is a reward for not approaching an obstacle. In addition, the reward R5 is a reward for not performing sudden deceleration or sudden acceleration.

Specifically, the reward is expressed by a formula (condition). Accordingly, the information processing apparatus 100 receives a formula (reward formula) representing a reward and a name of the reward (reward name), as the reward. In the example illustrated in FIG. 1, the information processing apparatus 100 receives, as the reward R1 for arriving at the destination, a reward formula “R1=A: {A is a variable that is 1 for arrival at the destination and 0 at other times}” and a reward name “arriving at the destination”. Furthermore, the information processing apparatus 100 receives, as the reward R2 for traveling to the destination at a high speed, a reward formula “R2=B: {B is the speed of the vehicle}” and a reward name “traveling to the destination at a high speed”. Furthermore, the information processing apparatus 100 receives, as the reward R3 for not hitting against an obstacle, a reward formula “R3=C: {C is a variable that is −1 when hitting against an obstacle and 0 at other times}” and a reward name “not hitting against an obstacle” Furthermore, the information processing apparatus 100 receives, as the reward R4 for not approaching the obstacle, a reward formula “R4=D: {D is a variable that is −1 when the distance to the obstacle falls below a predetermined threshold and 0 at other times}” and a reward name “not approaching the obstacle”. Furthermore, the information processing apparatus 100 receives, as the reward R5 for not performing sudden deceleration or sudden acceleration, a reward formula “R5=−E: {E is acceleration of vehicle}” and a reward name “not performing sudden deceleration or sudden acceleration”.

Furthermore, the information processing apparatus 100 receives a relatively small amount of training data as compared with the amount of training data used in learning by general behavior cloning. Specifically, the information processing apparatus 100 receives a plurality of pieces of training data (group) Xₙ (n is a natural number) related to a series of driving operations by a certain driver from a departure place to a destination. More specifically, the training data (group) Xₙ is (a group of) set data (Iₙ, Oₙ) being a set of input information Iₙ which is image information including a view ahead of the vehicle obtained from a departure place to a destination and output information Oₙ which is operation information indicating a driving operation of the vehicle corresponding to the view ahead of the vehicle. For example, each training data group Xₙ includes a plurality of pieces of set data (Iₙ, Oₙ). When the training data group Xₙ includes Tₙ (Tₙ is a natural number) pieces of set data, the training data group Xₙ is expressed as Xₙ={(Iₙ₁, Oₙ₁), (Iₙ₂, Oₙ₂), . . . , (I_{nTn}, O_{nTn})}. When the number of set data included in Xₙ is one, it is simply referred to as training data Xₙ.

In addition, the training data may include information regarding a driving operation that is difficult to express by presetting a reward. For example, the training data may include information regarding the personality and characteristics of the driving operation according to the subject who performs the driving operation. For example, when the designer desires to have the object to “learn a driving operation that follows a driving manner like oneself (the designer)”, the information processing apparatus 100 receives driving data of the designer as training data. Alternatively, in a case where the designer desires to have the object to “learn a driving operation following a driving manner like a professional driver A”, the information processing apparatus 100 receives driving data of the professional driver A as training data. Here, the driving manner includes driving operations difficult to express by presetting a reward, such as smoothness of driving, for example.

In the example illustrated in FIG. 1, the user U1 being a designer desires to “have the object to learn a driving operation like three drivers, namely, a professional driver A, a professional driver B, and a professional driver C since all three of the drivers A, B, and C are excellent at driving”. The information processing apparatus 100 receives, as training data, driving data of the three drivers, namely, the professional driver A, the professional driver B, and the professional driver C. Specifically, the information processing apparatus 100 receives a training data group Aᵢ (i is a natural number) including the driving data of the professional driver A, a training data group Bⱼ (j is a natural number) including the driving data of the professional driver B, and a training data group Cₖ (k is a natural number) including the driving data of the professional driver C.

Furthermore, the information processing apparatus 100 receives a range of the weight of each of rewards. Specifically, the information processing apparatus 100 receives a lower limit value and an upper limit value of the weight of each of rewards. Here, the weight of each of rewards indicates a weight regarding how much importance is to be placed on each of rewards in reinforcement learning as compared with other rewards. In the example illustrated in FIG. 1, the information processing apparatus 100 receives a lower limit value “1” and an upper limit value “1” of the weight w₁ of the reward R1. Note that matching between the lower limit value “1” and the upper limit value “1” means that the value of w₁ is designated as “1” by the user U1. Furthermore, the information processing apparatus 100 receives a lower limit value “5” and an upper limit value “10” of the weight w₂ of the reward R2. Furthermore, the information processing apparatus 100 receives a lower limit value “1” and an upper limit value “2” of the weight w₃ of the reward R3. Furthermore, the information processing apparatus 100 receives a lower limit value “0” and an upper limit value “1” of the weight w₄ of the reward R4. Furthermore, the information processing apparatus 100 receives a lower limit value “0” and an upper limit value “3” of the weight w₅ of the reward R5.

Subsequently, after receiving the range of the weight wₙ (n=1 to 5) of each of rewards Rn (n=1 to 5), the information processing apparatus 100 determines an input value of the weight of each of rewards used for reinforcement learning of the machine learning model based on the received range of the weight of each of rewards (step S2). Hereinafter, the input value of the weight of each of rewards used for reinforcement learning of the machine learning model may be referred to as an input reward ratio. For example, the information processing apparatus 100 randomly determines the input value of the weight of each of rewards so as to fall within the range of the received weight of each of rewards. For example, the information processing apparatus 100 determines an input value of the weight w₁ of the reward R1 as “1”, an input value of the weight w₂ of the reward R2 as “7”, an input value of the weight w₃ of the reward R3 as “1.5”, an input value of the weight w₄ of the reward R4 as “0.5”, and an input value of the weight w₅ of the reward R5 as “2”.

Subsequently, after determining the input value of the weight of each of rewards, the information processing apparatus 100 collects learning data used for reinforcement learning (step S3). For example, the information processing apparatus 100 collects a large amount of learning data, which is a set of image information including a view ahead of the vehicle obtained from a departure place to a destination and operation information indicating a driving operation of the vehicle corresponding to the view ahead of the vehicle, using a simulator for autonomous driving. Note that the large amount of learning data means that the amount of data is relatively larger than the amount of training data received by the information processing apparatus 100.

Subsequently, after collecting the learning data used for reinforcement learning, the information processing apparatus 100 trains the machine learning model with reinforcement learning based on the rewards R1 to R5 weighted by the input value of the weight of each of rewards (step S4). Specifically, each of the rewards R1 to R5 weighted by the weight of each of rewards is expressed by the following formula: “R=w₁*R1+w₂*R2+w₃*R3+w₄*R4+w₅*R5” That is, the rewards R1 to R5 weighted by the input value of the weight of each of rewards are expressed by the following formula:
“R₁=1*R1+7*R2+1.5*R3+0.5*R4+2*R5” The information processing apparatus 100 trains the machine learning model with reinforcement learning such that, when image information including a view ahead of the vehicle included in learning data has been input, the model will output operation information indicating a driving operation of the vehicle corresponding to the view ahead of the vehicle included in the learning data so as to maximize the reward R1 weighted by the input value of the weight of each of rewards.

Here, the machine learning model includes connection coefficients of a huge number, for example, 100,000 or 1 million. In step S4, the information processing apparatus 100 uses reinforcement learning to train a huge number of connection coefficients such as 100,000 or 1 million included in the machine learning model by using a large amount of learning data so as to maximize the reward R₁. Hereinafter, step S3 and step S4 are collectively referred to as a reinforcement learning phase. The reinforcement learning phase performs training of most of the connection coefficients of the machine learning model. Hereinafter, a part of the machine learning model which has been trained with reinforcement learning in the reinforcement learning phase will be referred to as model data MDT1. Note that another phase referred to as a reward adjustment phase to be described below is a phase of training a part of a machine learning model having a weight of each of rewards as a connection coefficient out of the machine learning model.

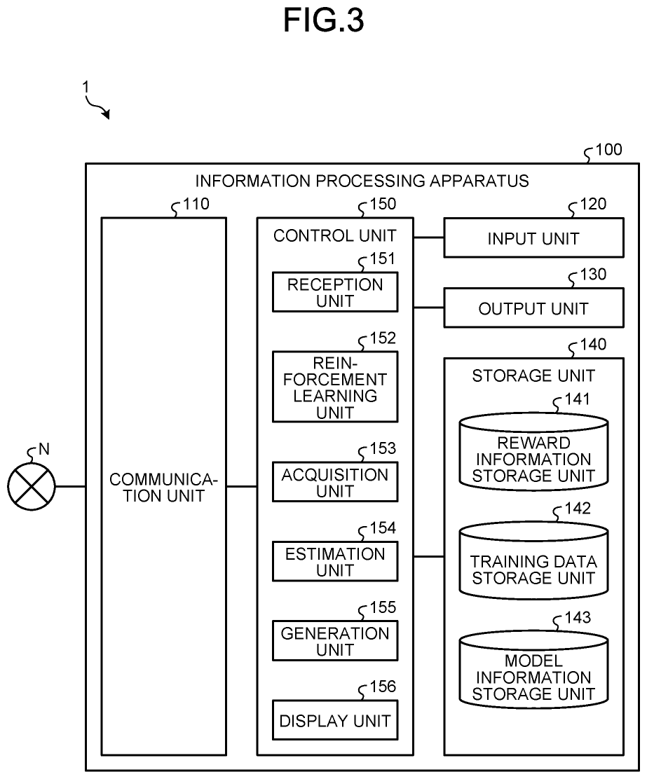

Subsequently, after training the machine learning model with reinforcement learning, the information processing apparatus 100 stores, in a storage unit 140, the model data MDT1 being most of the machine learning model that has been trained with the reinforcement learning (refer to FIG. 3). Subsequently, the information processing apparatus 100 acquires a machine learning model trained with reinforcement learning. Specifically, with reference to the storage unit 140 (refer to FIG. 3), the information processing apparatus 100 acquires the model data MDT1 being most of the machine learning model trained with reinforcement learning.

Subsequently, having acquired the machine learning model trained with the reinforcement learning, the information processing apparatus 100 estimates the weight of each of rewards by training the machine learning model in which the weight of each of rewards is defined as a part of the connection coefficient of the machine learning model trained with the reinforcement learning such that, when the image information included in the training data and the value based on the weight of each of rewards have been input, the model will output the operation information included in the training data (step S5). In the reward adjustment phase, the information processing apparatus 100 trains only a part of a machine learning model having a weight of each of rewards as a connection coefficient out of the machine learning model.

For example, in a case where the machine learning model is a neural network, the information processing apparatus 100 estimates the weight of each of rewards by training a neural network in which the weight of each of rewards is defined as a part of the neural network trained with reinforcement learning. Here, the value based on the weight of each of rewards is an arbitrary numerical value to be input to each input layer of a machine learning model corresponding to each connection coefficient being the weight of each of rewards. For example, the information processing apparatus 100 determines a value based on the weight of each of rewards as “1”.

Here, while the machine learning model typically includes a huge number of connection coefficients such as 100,000 or 1 million, the number of weights of each of rewards is very small (such as several to several tens). That is, the number of connection coefficients corresponding to the weight of each of rewards trained in step S5 is very small as compared with the number of connection coefficients trained with reinforcement learning in step S4, making it possible to appropriately learn the weight of each of rewards even with the small amount of training data used for the learning in step S5 as compared with the number of pieces of learning data used for reinforcement learning in step S4.

In addition, the information processing apparatus 100 estimates weights (wₙ₁, . . . wₙ₅) (=Wₙ) of each of rewards for each training data group Xₙ. For example, the information processing apparatus 100 estimates the weight Wₙ of each of rewards such that, when input information Iₙᵢ (i=1 to Tₙ) included in each training data group Xₙ and the value based on the weight of each of rewards are input to the machine learning model, a value obtained by dividing a sum of squared error of output information Oₙᵢ (i=1 to Tₙ) included in each training data group Xₙ and output information yᵢ actually output from the machine learning model by the number of pieces of data Tₙ will be minimized. The weight Wₙ of each of rewards estimated using each training data group Xₙ in this manner can be regarded as a characteristic label indicating a characteristic of each training data group Xₙ as well as indicating the reward ratio.

For example, in a case where the information processing apparatus 100 has received N (N is a natural number) training data groups X₁ to X_{N} from the user U1, the information processing apparatus 100 estimates the weights W₁ to W_{N} of the respective N rewards corresponding to the training data groups X₁ to X_{N}, respectively. Subsequently, after estimating the weights W₁ to W_{N} of the respective N rewards, the information processing apparatus 100 determines an estimation range of the weight of each of rewards based on the estimated weights W₁ to W_{N} of the respective N rewards (step S6). Hereinafter, the estimation range of the weight of each of rewards will be referred to as a reward ratio estimation width in some cases.

For example, the information processing apparatus 100 calculates a weighted mean of Wₙ in consideration of the number Tₙ of pieces of set data included in each training data group Xₙ, and determines the calculated value as an estimate μ of the weight of each of rewards. Alternatively, the information processing apparatus 100 may calculate a mean μ of the weights W₁ to W_{N} of the N rewards and determine the calculated value as the estimate μ of the weight of each of rewards.

Furthermore, after estimating the weights W₁ to W_{N} of the N rewards, the information processing apparatus 100 determines a variance σ of the weight of each of rewards based on the estimated weights W₁ to W_{N} of the N rewards. For example, the information processing apparatus 100 calculates a variance of the weights W₁ to W_{N} of the respective N rewards, and determines the calculated value as the variance σ of the weight of each of rewards. Alternatively, the information processing apparatus 100 may determine a fixed value corresponding to the number of learning steps as the variance σ.

Subsequently, having determined the estimate μ of the weight of each of rewards and the variance σ of the weight of each of rewards, the information processing apparatus 100 determines μ±σ as an estimation range (reward ratio estimation width) of the weight of each of rewards. Hereinafter, step S5 and step S6 are collectively referred to as a reward ratio adjustment phase.

The information processing apparatus 100 repeats the reinforcement learning phase and the reward ratio adjustment phase until the variance σ is close to 0. When the variance σ becomes 0, the weight of each of rewards is completely determined. Specifically, after having determined the reward ratio estimation width in step S6, the information processing apparatus 100 judges whether or not the variance σ is 0. When having judged that the variance σ is not 0, the information processing apparatus 100 returns to step S2 again. Returning to step S2, the information processing apparatus 100 randomly determines the input reward ratio of each of rewards so that the input reward ratio falls within the determined reward ratio estimation width. Subsequently, the information processing apparatus 100 repeats steps S2 to S6.

In contrast, when having judged that the variance σ is 0, the information processing apparatus 100 makes a judgment that the weight of each of rewards is determined. When having judged that the weight of each of rewards is determined, the information processing apparatus 100 displays information regarding the estimated weight Wₙ of each of rewards and information regarding the determined weight μ of each of rewards (step S7). Details of the UI screen displayed by the information processing apparatus 100 will be described below.

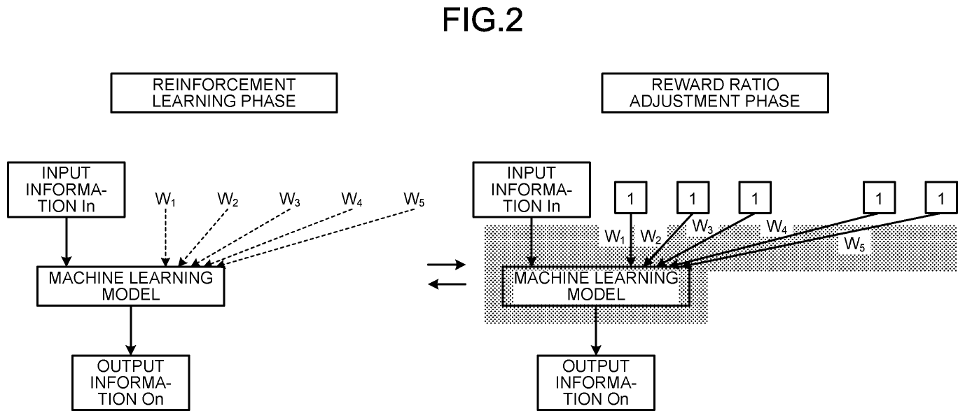

Next, the learning processing according to the embodiment of the present disclosure will be described in more detail with reference to FIG. 2. FIG. 2 is a diagram illustrating an example of learning processing according to the embodiment of the present disclosure. As illustrated in FIG. 2, an example of the learning processing according to the embodiment of the present disclosure is performed by repeating the reinforcement learning phase and the reward ratio adjustment phase.

The illustration on the left side of FIG. 2 is a diagram of an example of the reinforcement learning phase according to the embodiment of the present disclosure. In the reinforcement learning phase, the information processing apparatus 100 directly inputs the input value of the weight wₙ (n=1 to 5) of each of rewards Rn (n=1 to 5) to the machine learning model. In the example illustrated in FIG. 1, the information processing apparatus 100 directly inputs to the machine learning model, an input value “1” of the weight w₁ of the reward R1, an input value “7” of the weight w₂ of the reward R2, an input value “1.5” of the weight w₃ of the reward R3, an input value “0.5” of the weight w₄ of the reward R4, and an input value “2” of the weight w₅ of the reward R5, which are determined in step S2.

Subsequently, the information processing apparatus 100 uses reinforcement learning to train the machine learning model based on the reward R₁ (=1*R1+7*R2+1.5*R3+0.5*R4+2*R5) weighted by the input value of the weight of each of rewards and based on the learning data. Specifically, the information processing apparatus 100 uses reinforcement learning to train the machine learning model such that when the input information Iₙ being image information included in the learning data has been input, the model will output output information Oₙ being operation information included in the learning data so as to maximize the reward R₁.

In this manner, the information processing apparatus 100 uses reinforcement learning to train a huge number of connection coefficients such as 100,000 or 1 million included in the machine learning model so as to maximize the reward R1 based on a large amount of learning data.

The illustration on right side of FIG. 2 is a diagram of an example of the reward ratio adjustment phase according to the embodiment of the present disclosure. In the reward ratio adjustment phase, the information processing apparatus 100 trains a machine learning model in which the weight wₙ (n=1 to 5) of each of rewards Rn (n=1 to 5) is defined as a connection coefficient of a part of the machine learning model. In the example illustrated in FIG. 1, the information processing apparatus 100 inputs a value “1” based on the weight of each of rewards determined in step S5 to each input layer of the machine learning model corresponding to each connection coefficient being the weight of each of rewards.

Specifically, the information processing apparatus 100 trains a machine learning model in which the weight wₙ (n=1 to 5) of each of rewards Rn (n=1 to 5) is defined as a part of a connection coefficient of the machine learning model such that when input information Iₙ being image information included in training data and a value “1” based on a weight of each of rewards have been input, the model will output output information Oₙ being operation information included in the training data.

In this manner, the information processing apparatus 100 uses supervised learning to train a portion corresponding to each connection coefficient being a weight of each of rewards out of the machine learning model based on training data (in small amount) received from the user U1.

As described above, the information processing apparatus 100 acquires a machine learning model trained with reinforcement learning such that, when first state information (image information) indicating a first state has been input, the model will output first action information (operation information) indicating a first action corresponding to the first state based on the plurality of rewards Rn (n=1 to 5) weighted by the weight wₙ (n=1 to 5) of each of rewards Rn (n=1 to 5). Furthermore, the information processing apparatus 100 receives training data that is a set of second state information (image information) indicating a second state and second action information (operation information) indicating a second action corresponding to the second state. In addition, the information processing apparatus 100 displays information regarding the weight of each of rewards estimated by training the machine learning model in which the weight wₙ (n=1 to 5) of each of rewards Rn (n=1 to 5) is defined as a part of the connection coefficient of the machine learning model such that, when the second state information (image information) included in the training data and the value based on the weight of each of rewards have been input, the model will output the second action information (operation information) included in the training data.

With this configuration, the information processing apparatus 100 can support designing of the machine learning model trained with reinforcement learning so as to cause the robot to behave as intended by the designer. This makes it possible for the information processing apparatus 100 to support use of the machine learning model trained with the reinforcement learning.

### 1-2. Configuration of Information Processing System According to Embodiment

First, an example of a configuration of an information processing system according to the embodiment of the present disclosure will be described with reference to FIG. 3. FIG. 3 is a diagram illustrating a configuration example of an information processing system according to the embodiment of the present disclosure. As illustrated in FIG. 3, an information processing system 1 includes an information processing apparatus 100. Note that the information processing system 1 may include an external information processing apparatus other than the information processing apparatus 100. These various apparatuses are communicably connected by a wired or wireless connection via a network N (for example, the Internet). Note that the information processing system 1 illustrated in FIG. 3 may include any number of information processing apparatuses 100.

### 1-3. Configuration of Information Processing Apparatus According to Embodiment

Next, a configuration of an information processing apparatus according to the embodiment of the present disclosure will be described with reference to FIG. 3. FIG. 3 is a diagram illustrating a configuration example of the information processing apparatus according to the embodiment of the present disclosure. As illustrated in FIG. 3, the information processing apparatus 100 according to the embodiment of the present disclosure includes a communication unit 110, an input unit 120, an output unit 130, a storage unit 140, and a control unit 150.

(Communication Unit 110)

The communication unit 110 is implemented by a NIC, for example. The communication unit 110 is connected to the network N with a wired or wireless connection, and exchanges information with an external information processing apparatus.

(Input Unit 120)

The input unit 120 is an input device that receives various operations from the user. Specifically, the input unit 120 receives an input operation of various types of information from the user U1 via the UI screen provided by the information processing apparatus 100. In addition, the input unit 120 receives a selection operation, a change operation, a deletion operation, and a designation operation by the user U1 for various types of information displayed on the UI screen, via the UI screen displayed on the output unit 130. For example, the input unit 120 is realized by a keyboard, a mouse, an operation key, and the like.

(Output Unit 130)

The output unit 130 is a display device for displaying various types of information. Specifically, the output unit 130 displays the UI screen output from a display unit 156. For example, the output unit 130 is actualized by a liquid crystal display or the like. In a case where a touch panel is adopted as the information processing apparatus 100, the input unit 120 and the output unit 130 are integrated.

(Storage Unit 140)

The storage unit 140 is implemented by semiconductor memory elements such as random access memory (RAM) and flash memory, or other storage devices such as a hard disk or an optical disc. For example, the storage unit 140 stores an information processing program according to the embodiment. As illustrated in FIG. 3, the storage unit 140 includes a reward information storage unit 141, a training data storage unit 142, and a model information storage unit 143.

(Reward Information Storage Unit 141)

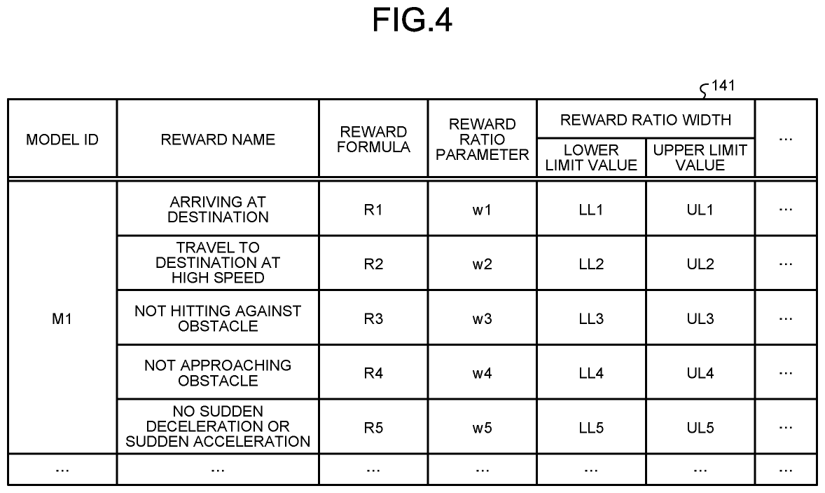

The reward information storage unit 141 stores various types of information regarding the reward received from the user U1. An example of the reward information storage unit according to the embodiment will be described with reference to FIG. 4. FIG. 4 is a diagram illustrating an example of the reward information storage unit according to the embodiment of the present disclosure. In the example illustrated in FIG. 4, the reward information storage unit 141 includes items such as “model ID”, “reward name”, “reward formula”, “reward ratio parameter”, and “reward ratio width”. Furthermore, the “reward ratio width” includes sub items such as “lower limit value” and “upper limit value”.

The “model ID” indicates identification information identifying the machine learning model. The “reward name” indicates a name of each of rewards received from the user U1. The “reward formula” indicates a formula of each of rewards received from the user U1. The “reward ratio parameter” indicates a weight of each of rewards. The “reward ratio width” indicates a range of the weight of each of rewards received from the user U1. The “lower limit value” indicates a lower limit value of the weight of each of rewards received from the user U1. The “upper limit value” indicates an upper limit value of the weight of each of rewards received from the user U1.

(Training Data Storage Unit 142)

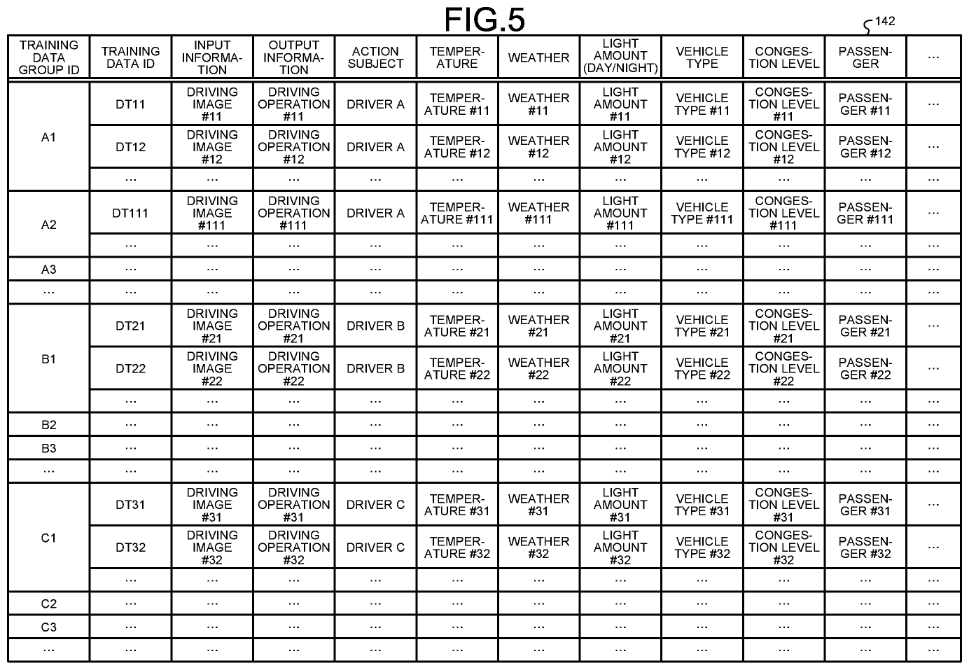

The training data storage unit 142 stores various types of information regarding the training data received from the user U1. An example of the training data storage unit according to the embodiment will be described with reference to FIG. 5. FIG. 5 is a diagram illustrating an example of the training data storage unit according to the embodiment of the present disclosure. In the example illustrated in FIG. 5, the training data storage unit 142 includes items such as “training data group ID”, “training data ID”, “input information”, “output information”, “action subject”, “temperature”, “weather”, “light amount (day/night)”, “vehicle type”, “congestion level”, and “passenger”.

The “training data group ID” indicates identification information identifying the training data group. The “training data ID” indicates identification information identifying each set data included in each training data group. The “input information” indicates image information including a view ahead of the vehicle obtained from a departure place to a destination. The “output information” indicates operation information indicating a driving operation of the vehicle corresponding to the view in front of the vehicle. “Action subject” indicates information regarding a driver who is a subject of a driving operation of the vehicle corresponding to the operation information. The “temperature” indicates information regarding the temperature when the driving operation corresponding to the operation information is performed. “Weather” indicates information regarding the weather when the driving operation corresponding to the operation information is performed. The “light amount (day/night)” indicates information regarding the light amount when the driving operation corresponding to the operation information is performed. For example, in a case where the driving operation corresponding to the operation information is performed in a time zone of daytime, “day” is stored in the item of “light amount (day/night)”. Furthermore, in a case where the driving operation corresponding to the operation information is performed in a time zone other than daytime, “night” is stored in the item of “light amount (day/night)”. The “vehicle type” indicates information regarding the vehicle type of the vehicle used for the driving operation corresponding to the operation information. The “congestion level” indicates information regarding a congestion level of the road when a driving operation corresponding to the operation information is performed. The “passenger” indicates information regarding a passenger sitting in the vehicle with the driver when the driving operation corresponding to the operation information was performed. For example, the item “passenger” stores information regarding the number of passengers and attributes of the passengers.

(Model Information Storage Unit 143)

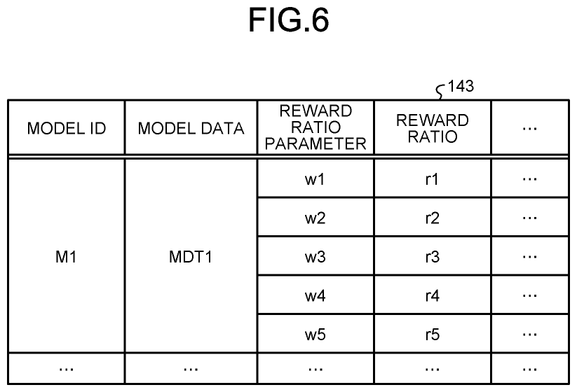

The model information storage unit 143 stores various types of information regarding the machine learning model trained by using the reinforcement learning by the information processing apparatus 100. An example of the model information storage unit according to the embodiment will be described with reference to FIG. 6. FIG. 6 is a diagram illustrating an example of the model information storage unit according to the embodiment of the present disclosure. In the example illustrated in FIG. 6, the model information storage unit 143 includes items such as “model ID”, “model data”, “reward ratio parameter”, and “reward ratio”.

The “model ID” indicates identification information identifying the machine learning model trained by using the reinforcement learning by the information processing apparatus 100. The “model data” indicates model data of the machine learning model trained by using the reinforcement learning by the information processing apparatus 100. For example, the “model data” includes information including a node in each layer, a function adopted by each node, a connection relationship between nodes, and a connection coefficient set for connection between nodes. The “reward ratio parameter” indicates a symbol when the weight of each of rewards is represented by a variable. The “reward ratio” indicates a value of a weight of each of rewards estimated by the information processing apparatus 100.

The model data MDT1 is a model including an input layer to which image information is input, an output layer, a first element belonging to any layer from the input layer to the output layer other than the output layer, and a second element whose value is calculated based on the first element and a weight of the first element, the model being a model for causing a computer to function so as to perform an arithmetic operation based on the first element and the weight of the first element, the first element being defined as each element belonging to each layer other than the output layer, the arithmetic operation being performed to output, from the output layer, operation information corresponding to the image information input to the input layer.

In addition, there is an assumable case where the machine learning model M1 is implemented by a neural network having one or a plurality of intermediate layers, such as a deep neural network (DNN). In this case, for example, the first element included in the machine learning model M1 corresponds to any node of the input layer or the intermediate layer. In addition, the second element corresponds to a node at a next stage which is a node to which a value is transmitted from a node corresponding to the first element. In addition, the weight of the first element corresponds to a connection coefficient being a weight considered for a value transmitted from the node corresponding to the first element to the node corresponding to the second element.

Here, the machine learning model M1 is assumed to be implemented by a regression model expressed by “y=a1*x1+a2*x2+ . . . +ai*xi”. In this case, for example, the first element included in the machine learning model M1 corresponds to input data (xi) such as x1, x2, and so on. Further, the weight of the first element corresponds to a coefficient ai corresponding to xi. Here, the regression model can be regarded as a simple perceptron having an input layer and an output layer. When each model is regarded as a simple perceptron, the first element can be regarded as any node included in the input layer, and the second element can be regarded as a node included in the output layer.

The model information storage unit 143 may store various types of model information according to a purpose, not limited to the above.

(Control Unit 150)

The control unit 150 is actualized by execution of various programs (corresponding to an example of an information processing program) stored in a storage device inside the information processing apparatus 100 by a central processing unit (CPU), a micro processing unit (MPU), or the like, using the RAM as a work area. Furthermore, the control unit 150 is actualized by, for example, an integrated circuit such as an application specific integrated circuit (ASIC) or a field programmable gate array (FPGA).

As illustrated in FIG. 3, the control unit 150 includes a reception unit 151, a reinforcement learning unit 152, an acquisition unit 153, an estimation unit 154, a generation unit 155, and a display unit 156, and implements or executes functions and actions of information processing described below. The internal configuration of the control unit 150 is not limited to the configuration illustrated in FIG. 3, and may be another configuration as long as it is a configuration that performs information processing described below.

(Reception Unit 151)

The reception unit 151 receives training data that is a set of second state information indicating the second state and second action information indicating the second action corresponding to the second state. The reception unit 151 receives a relatively small amount of training data as compared with the amount of training data used in the learning with general behavior cloning. Specifically, the reception unit 151 receives a plurality of pieces of training data (group) Xₙ (n is a natural number) related to a series of driving operations by a certain driver from a departure place to a destination. More specifically, the reception unit 151 receives set data (Iₙ, Oₙ) which is a set of input information Iₙ which is image information including a view ahead of the vehicle obtained from a departure place to a destination and output information Oₙ which is operation information indicating a driving operation of the vehicle corresponding to the view ahead of the vehicle. For example, when the training data group Xₙ includes Tₙ (Tₙ is a natural number) pieces of set data, the reception unit 151 receives the training data group Xₙ={(Iₙ₁,Oₙ₁), (Iₙ₂,Oₙ₂), . . . , (I_{nTn},O_{nTn})}. The reception unit 151 may receive the training data Xₙ including only one piece of set data. Subsequently, after having received a plurality of pieces of training data (group) Xₙ (n is a natural number), the reception unit 151 stores each received training data (group) Xₙ in the training data storage unit 142.

In addition, the reception unit 151 receives training data including information regarding a driving operation that is difficult to express by setting a reward. For example, in a case where the designer desires to have the model to “learn a driving operation that follows a driving manner like oneself (the designer)”, the reception unit 151 receives driving data of the designer as training data. Alternatively, in a case where the designer desires to have the model to “learn a driving operation with the smoothness like a professional driver A”, the reception unit 151 receives driving data of the professional driver A as training data.

In the example illustrated in FIG. 1, the user U1 being a designer desires to “have the object to learn a driving operation like three drivers, namely, a professional driver A, a professional driver B, and a professional driver C since all three of the drivers A, B, and C are excellent at driving”. The reception unit 151 receives, as training data, driving data of the three drivers, namely, the professional driver A, the professional driver B, and the professional driver C. Specifically, the reception unit 151 receives a training data group Aᵢ (i is a natural number) including the driving data of the professional driver A, a training data group Bⱼ (j is a natural number) including the driving data of the professional driver B, and a training data group Cₖ (k is a natural number) including the driving data of the professional driver C. Subsequently, after having received the training data group Aᵢ (i is a natural number), the training data group Bⱼ (j is a natural number), and the training data group Cₖ (k is a natural number), the reception unit 151 stores the received training data groups in the training data storage unit 142.

Furthermore, the reception unit 151 receives a range of the weight of each of rewards. Specifically, the reception unit 151 receives a lower limit value and an upper limit value of the weight of each of rewards. In the example illustrated in FIG. 1, the reception unit 151 receives a range of a weight wₙ (n=1 to 5) of each of rewards Rn (n=1 to 5). More specifically, the reception unit 151 receives a lower limit value “1” and an upper limit value “1” of the weight w₁ of the reward R1. In addition, the reception unit 151 receives a lower limit value “5” and an upper limit value “10” of the weight w₂ of the reward R2. In addition, the reception unit 151 receives a lower limit value “1” and an upper limit value “2” of the weight w₃ of the reward R3. In addition, the reception unit 151 receives a lower limit value “0” and an upper limit value “1” of the weight w₄ of the reward R4. In addition, the reception unit 151 receives a lower limit value “0” and an upper limit value “3” of the weight w₅ of the reward R5. Subsequently, after having received the lower limit value and the upper limit value of the weight wₙ (n=1 to 5) of each of rewards Rn (n=1 to 5), the reception unit 151 stores the received lower limit value and upper limit value of the weight wₙ (n=1 to 5) of each of rewards Rn (n=1 to 5) in the reward information storage unit 141 in association with each of rewards Rn.

Furthermore, the reception unit 151 receives information regarding a plurality of rewards. Specifically, the display unit 156 displays a list of rewards on the screen. For example, the display unit 156 selectively displays a plurality of rewards. The reception unit 151 receives a plurality of rewards Rn (n=1 to 5) selected by the user U1 from the list of rewards displayed on the display unit 156. Specifically, the reception unit 151 receives a formula (reward formula) representing a reward and a name of the reward (reward name), as the reward. Note that the reception unit 151 may receive the input of the reward formula and the reward name directly from the user U1. The display unit 156 displays information regarding at least one reward among the pieces of information regarding the plurality of rewards received by the reception unit 151.

In the example illustrated in FIG. 1, the reception unit 151 receives, as the reward R1 for arriving at the destination, a reward formula “R1=A: {A is a variable that is 1 for arrival at the destination and 0 at other times}” and a reward name “arriving at the destination”. Furthermore, the reception unit 151 receives, as the reward R2 for traveling to the destination at a high speed, a reward formula “R2=B: {B is the speed of the vehicle}” and a reward name “traveling to the destination at a high speed”. Furthermore, the reception unit 151 receives, as the reward R3 for not hitting against an obstacle, a reward formula “R3=C: {C is a variable that is −1 when hitting against an obstacle and 0 at other times}” and a reward name “not hitting against an obstacle”. Furthermore, the reception unit 151 receives, as the reward R4 for not approaching the obstacle, a reward formula “R4=D: {D is a variable that is −1 when the distance to the obstacle falls below a predetermined threshold and 0 at other times}” and a reward name “not approaching the obstacle”. Furthermore, the reception unit 151 receives, as the reward R5 for not performing sudden deceleration or sudden acceleration, a reward formula “R5=−E: {E is acceleration of vehicle}” and a reward name “not performing sudden deceleration or sudden acceleration”. Subsequently, after having received the reward formula and the reward name of each of rewards Rn (n=1 to 5), the reception unit 151 stores the received reward formula and reward name in the reward information storage unit 141 in association with each of rewards Rn.

(Reinforcement Learning Unit 152)

After receiving, by the reception unit 151, the range of the weight wₙ (n=1 to 5) of each of rewards Rn (n=1 to 5), the reinforcement learning unit 152 determines the input value of the weight of each of rewards used for training the machine learning model with reinforcement learning based on the received range of the weight of each of rewards. For example, the reinforcement learning unit 152 randomly determines the input value of the weight of each of rewards so that that value falls within the range of the received weight of each of rewards. In the example illustrated in FIG. 1, the reinforcement learning unit 152 determines the input value of the weight w₁ of the reward R1 as “1”, the input value of the weight w₂ of the reward R2 as “7”, the input value of the weight w₃ of the reward R3 as “1.5”, the input value of the weight w₄ of the reward R4 as “0.5”, and the input value of the weight w₅ of the reward R5 as “2”.

Subsequently, after determining the input value of the weight of each of rewards, the reinforcement learning unit 152 collects learning data used for reinforcement learning. Specifically, the reinforcement learning unit 152 collects learning data that is a set of first state information indicating a first state and first action information indicating a first action corresponding to the first state. In the example of FIG. 1, the reinforcement learning unit 152 collects a large amount of learning data, which is a set of image information including a view ahead of the vehicle obtained from a departure place to a destination and operation information indicating a driving operation of the vehicle corresponding to the view ahead of the vehicle, using a simulator for autonomous driving. The reinforcement learning unit 152 collects a relatively larger amount of learning data compared with the amount of training data received by the reception unit 151.

Subsequently, after collecting the learning data used for reinforcement learning, the reinforcement learning unit 152 uses reinforcement learning to train the machine learning model based on a plurality of rewards weighted by the input value of the weight of each of rewards. Specifically, based on the plurality of rewards weighted by the weight of each of rewards, the reinforcement learning unit 152 uses the reinforcement learning to train the machine learning model such that, when the first state information indicating the first state has been input, the model will output the first action information indicating the first action corresponding to the first state. After training the machine learning model by the reinforcement learning, the reinforcement learning unit 152 stores the machine learning model trained by the reinforcement learning in the model information storage unit 143.

In the example illustrated in FIG. 1, a plurality of rewards Rn weighted by the weight of each of rewards is expressed by the following formula:
“R=w₁*R1+w₂*R2+w₃*R3+w₄*R4+w₅*R5” That is, the rewards R1 to R5 weighted by the input value of the weight of each of rewards are expressed by the following formula:
“R₁=1*R1+7*R2+1.5*R3+0.5*R4+2*R5” The reinforcement learning unit 152 uses reinforcement learning to train the machine learning model such that, when image information including a view ahead of the vehicle included in learning data has been input, the model will output operation information indicating a driving operation of the vehicle corresponding to the view ahead of the vehicle included in the learning data so as to maximize the reward R1 weighted by the input value of the weight of each of rewards. The reinforcement learning unit 152 uses reinforcement learning to train a huge number of connection coefficients such as 100,000 or 1 million included in the machine learning model by using a large amount of learning data so as to maximize the reward R₁. After training the machine learning model by the reinforcement learning, the reinforcement learning unit 152 stores the machine learning model trained by the reinforcement learning in the model information storage unit 143.

(Acquisition Unit 153)

Based on the plurality of rewards weighted by the weight of each of rewards, the acquisition unit 153 acquires the machine learning model trained with reinforcement learning such that, when the first state information indicating the first state has been input, the model will output the first action information indicating the first action corresponding to the first state. Specifically, with reference to the model information storage unit 143, the acquisition unit 153 acquires the machine learning model trained with the reinforcement learning performed by the reinforcement learning unit 152.

In addition, the acquisition unit 153 acquires a machine learning model trained with reinforcement learning based on a plurality of rewards weighted by the weight of each of rewards falling within the range of the weight of each of the rewards received by the reception unit 151. In the example illustrated in FIG. 1, with reference to the model information storage unit 143, the acquisition unit 153 acquires the machine learning model trained with the reinforcement learning based on the plurality of rewards weighted by the input value of the weight of each of rewards randomly determined to fall within the range of the weight wₙ (n=1 to 5) of each of rewards Rn (n=1 to 5) received by the reception unit 151.

In addition, the acquisition unit 153 acquires a machine learning model trained with reinforcement learning based on a plurality of rewards based on information regarding the plurality of rewards received by the reception unit 151. In the example illustrated in FIG. 1, with reference to the model information storage unit 143, the acquisition unit 153 acquires a machine learning model trained with reinforcement learning based on a plurality of rewards Rn (n=1 to 5) received by the reception unit 151.

(Estimation Unit 154)

The estimation unit 154 estimates the weight of each of rewards by training the machine learning model in which the weight of each of rewards is defined as a part of the connection coefficient of the machine learning model trained by the reinforcement learning such that, when the image information included in the training data and the value based on the weight of each of rewards have been input, the model will output the operation information included in the training data. For example, in a case where the machine learning model is a neural network, the estimation unit 154 trains a neural network in which the weight of each of rewards is a part of the neural network trained with the reinforcement learning and thereby estimates the weight of each of rewards. For example, the estimation unit 154 determines an arbitrary numerical value as a value based on the weight of each of rewards and inputs the determined value to the machine learning model. For example, the estimation unit 154 inputs “1” to the machine learning model as a value based on the weight of each of rewards.

Furthermore, the estimation unit 154 estimates a weight (wₙ₁, . . . , wₙ₅) (=Wₙ) of each of rewards for each training data group Xₙ. For example, the estimation unit 154 estimates the weight Wₙ of each of rewards such that, when the input information Iₙᵢ (i=1 to Tₙ) included in each training data group Xₙ and the value based on the weight of each of rewards have been input to the machine learning model, a value obtained by dividing a sum of squared error of output information Oₙᵢ (i=1 to Tₙ) included in each training data group Xₙ and output information yᵢ actually output from the machine learning model by the number of pieces of data T n will be minimized.

For example, when the reception unit 151 receives N (N is a natural number) training data groups X₁ to X_{N} from the user U1, the estimation unit 154 estimates the weights W₁ to W_{N} of the respective N rewards corresponding to the training data groups X₁ to X_{N}, respectively. Subsequently, after estimating the weights W₁ to W_{N} of the respective N rewards, the estimation unit 154 determines an estimation range of the weight of each of rewards based on the estimated weights W₁ to W_{N} of the respective N rewards.

Specifically, the estimation unit 154 determines the mean μ of the weights of each of rewards based on the estimated weights W₁ to W_{N} of the respective N rewards. For example, the estimation unit 154 calculates a weighted mean of Wₙ in consideration of the number Tₙ of pieces of set data included in each training data group Xₙ, and determines the calculated value as the mean μ of the weight of each of rewards. Alternatively, the estimation unit 154 may calculate the mean μ of the weights W₁ to W_{N} of the N rewards and determine the calculated value as the mean μ of the weights of the respective rewards. Furthermore, the estimation unit 154 determines a variance σ of the weights of the respective rewards based on the estimated weights W₁ to W_{N} of the respective N rewards. For example, the estimation unit 154 calculates a variance of the weights W₁ to W_{N} of the respective N rewards, and determines the calculated value as the variance σ of the weights of the respective rewards. Alternatively, the estimation unit 154 may determine a fixed value corresponding to the number of learning steps as the variance σ.

Subsequently, after having determined the mean μ and the variance σ of the weights of the respective rewards, the estimation unit 154 determines μ±σ as an estimation range (reward ratio estimation width) of the weights of the respective rewards.

The estimation unit 154 repeats the reinforcement learning phase and the reward ratio adjustment phase until the variance σ is close to 0. Specifically, when determining the reward ratio estimation width, the estimation unit 154 judges whether or not the variance σ is 0. When judging that the variance σ is not 0, the estimation unit 154 returns to the reinforcement learning phase again. Returning to the reinforcement learning phase, the estimation unit 154 randomly determines the input reward ratio of each of rewards so that the input reward ratio falls within the determined reward ratio estimation width.

On the other hand, in a case where the variance σ is judged to be 0, the estimation unit 154 judges that the weight of each of rewards is determined. When having judged that the weight of each of rewards is determined, the estimation unit 154 stores the determined weight rn of each of rewards in the reward information storage unit 141 in association with each of rewards Rn.

(Generation Unit 155)

The generation unit 155 generates various types of information based on the information regarding the weight Wₙ of each of rewards estimated by the estimation unit 154 and the information regarding the weight rn of each of rewards determined by the estimation unit 154. For example, the generation unit 155 generates a UI screen that displays information regarding the weight Wₙ of each of rewards estimated by the estimation unit 154.

(Display Unit 156)

The display unit 156 displays information regarding the weight of each of rewards estimated by training the machine learning model in which the weight of each of rewards is defined as a part of the connection coefficient of the machine learning model such that, when second state information included in the training data and the value based on the weight of each of rewards have been input, the model will output second action information included in the training data. Specifically, the display unit 156 displays the UI screen generated by the generation unit 155 on the output unit 130.

### 1-4. Procedure of Information Processing According to Embodiment

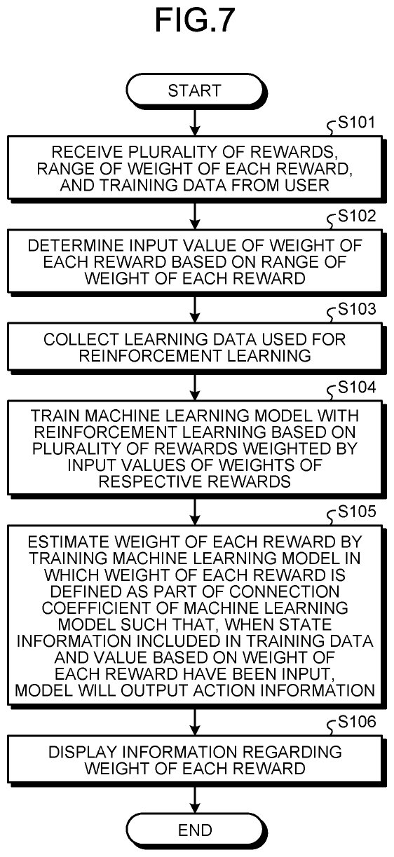

Next, a procedure of information processing according to the embodiment of the present disclosure will be described with reference to FIG. 7. FIG. 7 is a flowchart illustrating a procedure of information processing according to the embodiment of the present disclosure.

In the example illustrated in FIG. 7, the information processing apparatus 100 receives a plurality of rewards, a range of weights of the respective rewards, and training data from the user (step S101).

Subsequently, after receiving the plurality of rewards, the range of the weight of each of rewards, and the training data, the information processing apparatus 100 determines an input value of the weight of each of rewards based on the received range of the weight of each of rewards (step S102).

Subsequently, after determining the input value of the weight of each of rewards, the information processing apparatus 100 collects learning data to be used for reinforcement learning (step S103).

Subsequently, after collecting the learning data to be used for reinforcement learning, the information processing apparatus 100 uses reinforcement learning to train the machine learning model based on a plurality of rewards weighted by the weight of each of the rewards (step S104).

Subsequently, after training the machine learning model with reinforcement learning, the information processing apparatus 100 estimates the weight of each of rewards by training the machine learning model in which the weight of each of rewards is defined as a part of the connection coefficient of the machine learning model such that, when the state information included in the training data and the value based on the weight of each of rewards have been input, the model will output the action information included in the training data (step S105).

Subsequently, after estimating the weight of each of rewards, the information processing apparatus 100 displays information regarding the estimated weight of each of rewards (step S106).

### 1-5. Example of UI Screen According to Embodiment

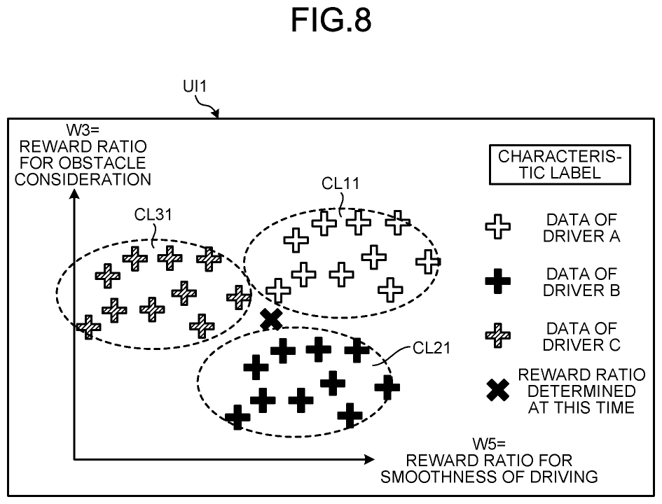

Next, an example of a UI screen according to the embodiment of the present disclosure will be described with reference to FIGS. 8 to 21.

### 1-5-1. Example of UI Screen According to Embodiment

First, an example of a UI screen according to the embodiment of the present disclosure will be described with reference to FIG. 8. FIG. 8 is a view illustrating an example of a UI screen according to the embodiment of the present disclosure. FIG. 8 illustrates an example of a UI screen including a graph displaying an estimation result regarding the weight of each of rewards obtained by the estimation unit 154.

In the example illustrated in FIG. 8, the display unit 156 displays a graph with the weight w₃ of the reward R3 and the weight w₅ of the reward R5 defined as axes among the weights wₙ (n=1 to 5) of each of rewards Rn (n=1 to 5). Specifically, with reference to the reward information storage unit 141, the generation unit 155 generates a graph with the weight w₃ of the reward R3 and the weight w₅ of the reward R5 defined as axes among the weights wₙ (n=1 to 5) of each of the rewards Rn (n=1 to 5). Subsequently, the generation unit 155 generates a content UI1 (corresponding to a UI screen) including the generated graph. Subsequently, the display unit 156 displays the content UI1 generated by the generation unit 155 on the output unit 130. In this manner, the display unit 156 displays a graph having the weight of at least one reward among the weights of the respective rewards defined as an axis.

In addition, the display unit 156 displays information indicating the weight w₃ of the reward R3 and the weight w₅ of the reward R5 among the weights wₙ (n=1 to 5) of the respective rewards Rn (n=1 to 5) estimated by the estimation unit 154. Specifically, the generation unit 155 generates a scatter plot representing information indicating the weight w₃ of the reward R3 and the weight w₅ of the reward R5 estimated by the estimation unit 154. Subsequently, the generation unit 155 generates the content UI1 corresponding to the UI screen including the generated scatter plot. Subsequently, the display unit 156 displays the content UI1 generated by the generation unit 155 on the output unit 130. In this manner, the display unit 156 displays information indicating the weight of at least one reward among the weights of the respective rewards estimated based on the training data.

For example, the display unit 156 displays information indicating a weight r₃ of the reward R3 and a weight r₅ of the reward R5 among weights rn of each of rewards determined by the estimation unit 154. For example, the display unit 156 generates a scatter plot representing information indicating the weight r³ of the reward R3 and the weight r⁵ of the reward R5 determined by the estimation unit 154 (a cross corresponding to the “reward ratio determined this time” illustrated in FIG. 8). Subsequently, the generation unit 155 generates the content UI1 corresponding to the UI screen including the generated scatter plot. Subsequently, the display unit 156 displays the content UI1 generated by the generation unit 155 on the output unit 130.

The training data includes subject information regarding a subject of the action of the second action information, and the display unit 156 displays information indicating weights of rewards illustrated in different colors according to differences in subjects. Specifically, with reference to the item of the action subject in the training data storage unit 142, the generation unit 155 generates a scatter plot that displays information indicating the weight of each of rewards estimated by the estimation unit 154 in different colors for each action subject. Subsequently, the generation unit 155 generates the content UI1 corresponding to the UI screen including the generated scatter plot. Subsequently, the display unit 156 displays the content UI1 generated by the generation unit 155 on the output unit 130.

In the example illustrated in FIG. 8, the display unit 156 displays, on the output unit 130, content UI1 including a scatter plot in which information indicating the weight of each of rewards estimated by the estimation unit 154 based on a training data group Ai (i is a natural number) including the driving data of a professional driver A is represented by a red cross (cross corresponding to “data of driver A” illustrated in FIG. 8). In FIG. 8 and the subsequent figures, the red cross is indicated by a white cross.

In addition, the display unit 156 displays, on the output unit 130, content UI1 including a scatter plot in which information indicating the weight of each of rewards estimated by the estimation unit 154 based on a training data group Bⱼ (j is a natural number) including the driving data of a professional driver B is represented by a blue cross (cross corresponding to “data of driver B” illustrated in FIG. 8). In FIG. 8 and the subsequent drawings, the blue cross is indicated by a black cross.

In addition, the display unit 156 displays, on the output unit 130, content UI1 including a scatter plot in which information indicating the weight of each of rewards estimated by the estimation unit 154 based on a training data group Cₖ (k is a natural number) including the driving data of a professional driver C is represented by a green cross (cross corresponding to “data of the driver C” illustrated in FIG. 8). In FIG. 8 and the subsequent figures, the green cross is indicated by a hatched cross.

Here, a conceivable reason for the variation in the weights of each of rewards estimated based on the training data including the driving data of a same driver would be a circumstance in which even the same driver does not always perform the driving operation based on the same law, and a difference can occur in each driving operation depending on the driving situation, the mood of the driver, and the like.

As illustrated in FIG. 8, the weight of each of rewards estimated by the estimation unit 154 can be regarded as a characteristic label indicating a characteristic of each training data group. For example, information (white cross) indicating the weight of each of rewards estimated based on the driving data of the professional driver A can be regarded as a characteristic label indicating the characteristic of the training data group Aᵢ including the driving data of the professional driver A. In addition, the information (black cross) indicating the weight of each of rewards estimated based on the driving data of the professional driver B can be regarded as a characteristic label indicating the characteristic of the training data group Bᵢ including the driving data of the professional driver B; and for example, the information (hatched cross) indicating the weight of each of rewards estimated based on the driving data of the professional driver C can be regarded as a characteristic label indicating the characteristic of the training data group Cᵢ including the driving data of the professional driver C.

Furthermore, the information indicating the weight of each of rewards estimated by the estimation unit 154 forms a cluster according to the characteristic of the training data group. For example, information (white cross) indicating the weight of each of rewards estimated based on the training data group Aᵢ including the driving data of the professional driver A forms a cluster CL11 according to the characteristic of the driving data of the driver A. In addition, information (black cross) indicating the weight of each of rewards estimated based on the training data group Bⱼ (j is a natural number) including the driving data of the professional driver B forms a cluster CL21 according to the characteristic of the driving data of the driver B. In addition, information (hatched cross) indicating the weight of each of rewards estimated based on the training data group Cₖ (k is a natural number) including the driving data of the professional driver C forms a cluster CL31 according to the characteristics of the driving data of the driver C.

In other words, the fact that the weight of each of rewards estimated by the estimation unit 154 is divided into a plurality of clusters means that the characteristics of the training data groups belonging to each cluster are different from each other. Accordingly, the information processing apparatus 100 can provide the user U1 with information that there is a difference among the characteristics of the driving data of the driver A included in the cluster CL11, the characteristics of the driving data of the driver B included in the cluster CL21, and the characteristics of the driving data of the driver C included in the cluster CL31.

In this manner, by estimating the weight of each of rewards, the information processing apparatus 100 can roughly examine the characteristics of each training data group used for the estimation. Furthermore, the information processing apparatus 100 can provide the user U1 with information regarding the characteristics of each training data group used for estimation. In addition, the information processing apparatus 100 can cluster each training data group based on the characteristics of each training data group.

### 1-5-2. Example of UI Screen According to Embodiment

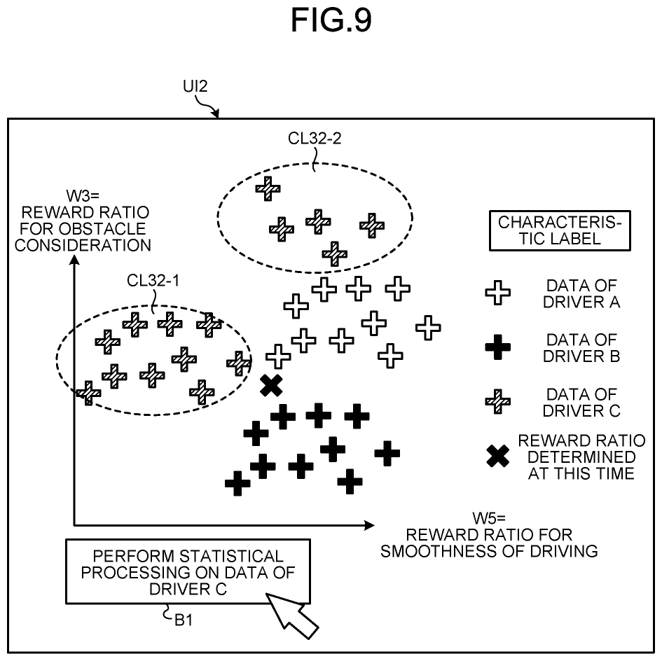

Next, an example of a UI screen according to the embodiment of the present disclosure will be described with reference to FIG. 9. FIG. 9 is a view illustrating an example of a UI screen according to the embodiment of the present disclosure. FIG. 9 illustrates an example of a UI screen including a graph displaying an estimation result regarding the weight of each of rewards obtained by the estimation unit 154.

In the example illustrated in FIG. 9, unlike FIG. 8, the display unit 156 displays a UI button B1 that enables statistical processing on information (hatched cross) indicating the weight of each of rewards estimated based on the training data group Ck (k is a natural number) including the driving data of the professional driver C. Specifically, the generation unit 155 generates a UI button that enables statistical processing on the information indicating the weight of each of rewards estimated by the estimation unit 154. For example, with reference to an item of an action subject in the training data storage unit 142, the generation unit 155 generates a UI button that enables statistical processing for each action subject.

In the example illustrated in FIG. 9, the generation unit 155 generates the UI button B1 that enables statistical processing on information indicating the weight of each of rewards estimated based on the training data group Cₖ (k is a natural number) including the driving data of the professional driver C. Subsequently, the generation unit 155 generates content UI2 including the generated UI button B1. After generating the content UI2, the display unit 156 displays the generated content UI2 on the output unit 130.

In addition, unlike FIG. 8, FIG. 9 illustrates a state in which information (cross corresponding to “data of the driver C” illustrated in FIG. 9) indicating the weight of each of rewards estimated by the estimation unit 154 based on the training data group Cₖ (k is a natural number) including the driving data of the professional driver C is distributed separately in two clusters CL32-1 and CL32-2.

With this configuration, the information processing apparatus 100 can allow the user U1 viewing the UI screen to visually recognize that the weight of each of rewards estimated based on the driving data of the same driver C is divided into two clusters. Moreover, as described above, the fact that the weight of each of rewards estimated by the estimation unit 154 is divided into a plurality of clusters means that the characteristics of the training data groups belonging to each cluster are different from each other. Therefore, the information processing apparatus 100 can provide the user U1 with information that the characteristics of the driving data of the driver C included in the cluster CL32-1 are different from the characteristics of the driving data of the driver C included in the cluster CL32-2. For example, the user U1 can notice a difference in the characteristics that the data included in the cluster CL32-1 is distributed on the side where the weight W₃ of the reward R3 for obstacle consideration is larger, compared with the data included in the cluster CL32-2.

The user U1 who has obtained the information provided by the information processing apparatus 100 selects, for example, information indicating the weight of the reward included in the cluster CL32-1 in order to investigate the reason why the characteristics of the driving data of the driver C included in the cluster CL32-1 are different from the characteristics of the driving data of the driver C included in the cluster CL32-2. The reception unit 151 receives a selection operation for the information indicating the weight of the reward displayed by the display unit 156. When the selection operation has been received, the display unit 156 displays information regarding training data corresponding to the information indicating the weight of the reward selected by the selection operation.

For example, with reference to the training data storage unit 142, the display unit 156 specifies the training data ID of the training data used to estimate the weight of the selected reward. For example, after having specified the training data ID, the display unit 156 displays the driving image information corresponding to the specified training data ID on the output unit 130. Similarly, the user U1 selects some pieces of information indicating weights of rewards included in the cluster CL32-1. With this configuration, the user U1 can notice, for example, that the driving images of the training data corresponding to the information indicating the weight of the reward included in the cluster CL32-1 are all driven in the bright time zone (daytime). In addition, the user U1 selects some pieces of information indicating weights of rewards included in the other cluster CL32-2. With this configuration, for example, the user U1 can notice that the driving images of the training data corresponding to the information indicating the weight of the reward included in the cluster CL32-2 are all driven in the dark time zone (nighttime).

In addition, the user U1 can make a hypothesis that “there is a possibility that the driver C chose a driving operation in consideration of an obstacle more in the dark time zone (nighttime) than in the bright time zone (daytime) in order to pay attention to safety more in the dark time zone (nighttime) than in a bright time zone (daytime) and that this might cause a difference in the characteristics of the driving data of the driver C between the cluster CL32-1 of the bright time zone (daytime) and the cluster CL32-2 of the dark time zone (nighttime).”

In addition, having obtained the information provided by the information processing apparatus 100, the user U1 selects the UI button B1 that enables statistical processing on the data of the driver C, for example, in order to investigate the reason why there is a difference between the characteristics of the driving data of the driver C included in the cluster CL32-1 and the characteristics of the driving data of the driver C included in the cluster CL32-2. For example, in order to verify the hypothesis, the user U1 can use the UI button B1 that enables statistical processing on the data of the driver C. The reception unit 151 receives the selection operation of the UI button B1 by the user U1.

Although not illustrated, the display unit 156 may also display, on the output unit 130, content U2 including, in addition to the UI button B1, a UI button B11 that enables statistical processing on information (white cross) indicating the weight of each of rewards estimated based on the training data group Aᵢ including the driving data of the professional driver A as well as a UI button B12 that enables statistical processing on information (black cross) indicating the weight of each of rewards estimated based on the training data group Bⱼ (j is a natural number) including the driving data of the professional driver B.

In this manner, the display unit 156 displays the UI button that enables statistical processing on the information indicating the weight of each of rewards. Specifically, the generation unit 155 generates the content UI2 corresponding to a UI screen including a UI button that enables statistical processing on information indicating the weight of each of rewards. Subsequently, the display unit 156 displays the content UI2 generated by the generation unit 155 on the output unit 130.

### 1-5-3. Example of UI Screen According to Embodiment

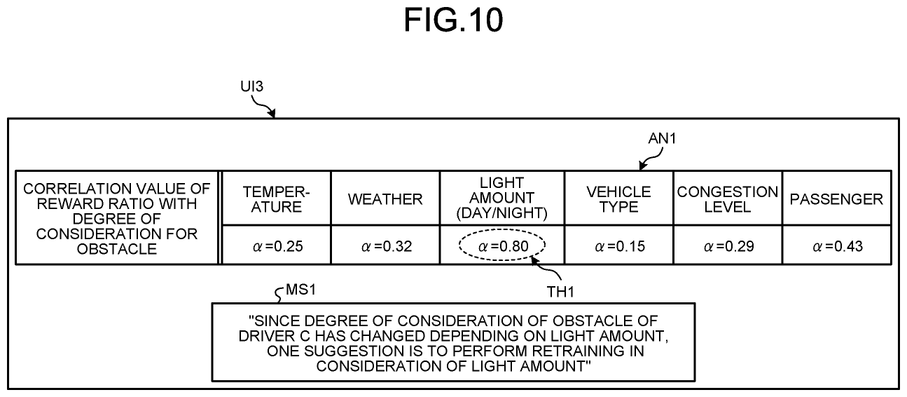

Next, an example of a UI screen according to the embodiment of the present disclosure will be described with reference to FIG. 10. FIG. 10 is a view illustrating an example of a UI screen according to the embodiment of the present disclosure. The UI screen illustrated in FIG. 10 is a diagram illustrating an example of a UI screen displayed after the reception of the selection operation of the UI button B1 illustrated in FIG. 9.

In the example illustrated in FIG. 10, the display unit 156 displays correlation information AN1 indicating a correlation between the weight w₃ of the reward R3 estimated based on the training data group Cₖ (k is a natural number) including the driving data of the driver C and each piece of environmental information included in the training data group Cₖ including the driving data of the driver C. Specifically, the generation unit 155 calculates a correlation value between the weight w₃ of the reward R3 and each piece of environmental information such as the temperature, the weather, and the light amount when the driving operation by the driver C is performed, the vehicle type used for the driving operation, the congestion level of the road when the driving operation is performed, and information regarding a passenger of the vehicle when the driving operation is performed.

After calculating the correlation value, the generation unit 155 judges whether or not the calculated correlation value exceeds a predetermined threshold TH1. When having judged that the calculated correlation value exceeds the predetermined threshold TH1, the generation unit 155 displays the correlation value after judgment so as to be visible to the user U1. For example, the generation unit 155 displays the correlation value exceeding the predetermined threshold value TH1 in red to visually stand out from other correlation values. In the example illustrated in FIG. 10, the generation unit 155 judges that the correlation value regarding the light amount exceeds the predetermined threshold TH1 (for example, TH1=0.7). Subsequently, when having judged that the correlation value related to the light amount exceeds the predetermined threshold TH1, the generation unit 155 surrounds the correlation value related to the light amount with a dotted circle to display the correlation value to visually stand out from other correlation values.

After calculating the correlation value, the generation unit 155 generates a table AN1 that displays the calculated correlation values. After generating the table AN1, the generation unit 155 generates content U13 including the table AN1. The display unit 156 displays the content U13 generated by the generation unit 155 on the output unit 130.

In this manner, the training data includes the environmental information regarding the environment in the second state, the statistical information is the correlation information indicating the correlation between the weight of the reward and the environmental information, and the display unit 156 displays the correlation information. In addition, the display unit 156 displays statistical information regarding the weight of at least one reward among the weights of the respective rewards estimated based on the training data.

After having judged that the correlation value related to the light amount exceeds the predetermined threshold TH1, the generation unit 155 judges that there is a high correlation between the weight w₃ of the reward R3 and the light amount. When having judged that there is a high correlation between the weight w₃ of the reward R3 and the light amount, the generation unit 155 generates a message MS1 prompting retraining in consideration of the reward regarding the light amount. For example, the generation unit 155 generates a message MS1 indicating that “since the degree of consideration of the obstacle of the driver C has changed depending on the light amount, one suggestion is to perform retraining in consideration of the light amount”. When generating the message MS1, the generation unit 155 generates content U13 including the generated message MS1. The display unit 156 displays the content U13 generated by the generation unit 155 on the output unit 130.

In this manner, the display unit 156 displays a message related to the suggestion of retraining based on the statistical information. More specifically, based on the correlation information, the display unit 156 displays a message related to a suggestion of retraining in consideration of a reward based on the environmental information.

With this configuration, the information processing apparatus 100 can provide information regarding the correlation between the weight of each of rewards estimated based on each training data group and each piece of environmental information included in each training data group, making it possible to provide information necessary for achieving learning with higher accuracy. For example, the information processing apparatus 100 can provide information regarding a reward necessary (lacking) for achieving learning with higher accuracy.

### 1-5-4. Example of UI Screen According to Embodiment

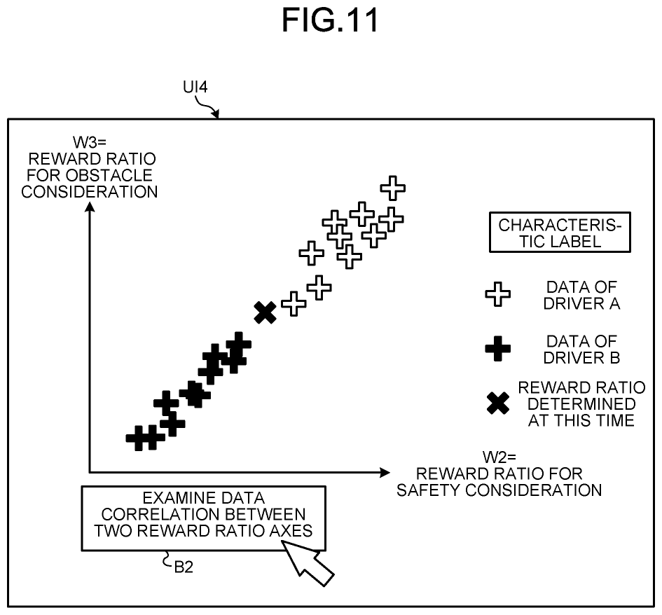

Next, an example of a UI screen according to the embodiment of the present disclosure will be described with reference to FIG. 11. FIG. 11 is a view illustrating an example of a UI screen according to the embodiment of the present disclosure.

Unlike FIG. 9, the display unit 156 in the example illustrated in FIG. 11 displays a UI button B2 that enables statistical processing of examining a correlation between weights of two rewards among the estimated weights of respective rewards. Specifically, the generation unit 155 generates a UI button that enables statistical processing of examining a correlation between the weights of the two rewards with reference to the reward information storage unit 141 among the weights of the respective rewards estimated by the estimation unit 154.

In the example illustrated in FIG. 11, the generation unit 155 generates the UI button B2 that enables statistical processing of examining the correlation between the weight w₃ of the reward R3 and the weight w₂ of the reward R2. Subsequently, the generation unit 155 generates content UI4 including the generated UI button B2. After generating the content UI4, the display unit 156 displays the generated content UI4 on the output unit 130.

In addition, unlike FIG. 9, FIG. 11 illustrates a state of nearly linear distribution of information (white cross) indicating the weight of each of rewards estimated by the estimation unit 154 based on the training data group Aᵢ including the driving data of the professional driver A and information (black cross) indicating the weight of each of rewards estimated by the estimation unit 154 based on the training data group Bⱼ (j is a natural number) including the driving data of the professional driver B.

With this configuration, the information processing apparatus 100 can allow the user U1 viewing the UI screen to visually recognize that the weight of each of rewards estimated based on the driving data of the driver A and the weight of each of rewards estimated based on the driving data of the driver B have a nearly linear relationship. Therefore, the information processing apparatus 100 can provide the user U1 with information that there can be some correlation between the weight w₃ of the reward R3 and the weight w₂ of the reward R2.

After having obtained the information provided by the information processing apparatus 100, the user U1 selects the UI button B2 that enables statistical processing of examining the correlation between the weights of the two rewards among the estimated weights of the respective rewards in order to examine whether there is also a correlation between the weights of the other rewards, for example. The reception unit 151 receives the selection operation of the UI button B2 by the user U1.

### 1-5-5. Example of UI Screen According to Embodiment

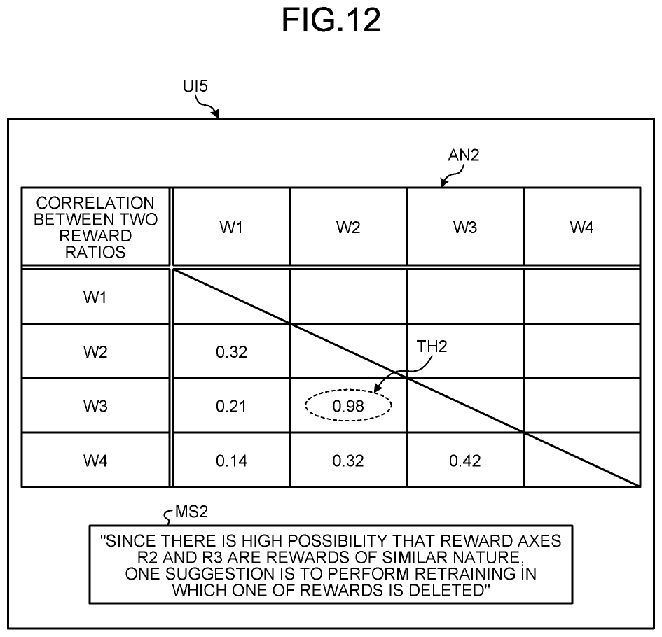

Next, an example of a UI screen according to the embodiment of the present disclosure will be described with reference to FIG. 12. FIG. 12 is a view illustrating an example of a UI screen according to the embodiment of the present disclosure. The UI screen illustrated in FIG. 12 is a diagram illustrating an example of a UI screen displayed after the reception of the selection operation of the UI button B2 illustrated in FIG. 11.

In the example illustrated in FIG. 12, the display unit 156 displays correlation information AN2 indicating a correlation between weights of two rewards. Specifically, the generation unit 155 calculates a correlation value between weights of respective rewards estimated by the estimation unit 154 based on each of training data groups. For example, the generation unit 155 calculates a correlation value between the weight w₂ of the reward R2 and the weight w₃ of the reward R3 estimated by the estimation unit 154 based on each of training data groups.

After calculating the correlation value, the generation unit 155 judges whether or not the calculated correlation value exceeds a predetermined threshold TH2. When having judged that the calculated correlation value exceeds the predetermined threshold TH2, the generation unit 155 displays the correlation value after judgment so as to be visible to the user U1. For example, the generation unit 155 displays the correlation value exceeding the predetermined threshold value TH2 in red to visually stand out from other correlation values. In the example illustrated in FIG. 12, the generation unit 155 judges that the correlation value between the weight w₂ of the reward R2 and the weight w₃ of the reward R3 exceeds the predetermined threshold TH2 (for example, TH2=0.8). Subsequently, when having judged that the correlation value between the weight w₂ of the reward R2 and the weight w₃ of the reward R3 exceeds the predetermined threshold TH2, the generation unit 155 uses a dotted circle to surround the correlation value between the weight w₂ of the reward R2 and the weight w₃ of the reward R3 to display the correlation value to visually stand out from other correlation values.

After calculating the correlation value, the generation unit 155 generates a table AN2 that displays the calculated correlation value. After generating the table AN2, the generation unit 155 generates content UI4 including the table AN2. The display unit 156 displays the content UI4 generated by the generation unit 155 on the output unit 130.

In this manner, the statistical information is correlation information indicating a correlation between weights of at least any two rewards among weights of the respective rewards, and the display unit 156 displays the correlation information.

When having judged that the correlation value between the weight w₂ of the reward R2 and the weight w₃ of the reward R3 exceeds the predetermined threshold TH2, the generation unit 155 judges that there is a high correlation between the weight w₂ of the reward R2 and the weight w₃ of the reward R3. When having judged that there is a high correlation between the weight w₂ of the reward R2 and the weight w₃ of the reward R3, the generation unit 155 generates a message MS2 prompting retraining in which one of the reward R2 and the reward R3 is deleted. For example, the generation unit 155 generates a message MS2 indicating that “since there is a high possibility that the reward R2 and the reward R3 are rewards of similar nature, one suggestion is to perform retraining in which one of the rewards is deleted”. When generating the message MS2, the generation unit 155 generates content UI5 including the generated message MS2. The display unit 156 displays the content UI5 generated by the generation unit 155 on the output unit 130.

In this manner, the display unit 156 displays a message related to the suggestion of retraining based on the statistical information. More specifically, the display unit 156 displays a message related to the suggestion of retraining in which at least one reward out of each of rewards has been deleted based on the correlation information.

With this configuration, the information processing apparatus 100 can provide information regarding the correlation between the weights of the respective rewards estimated based on the each of training data groups, and thus, can provide information necessary for achieving learning with higher accuracy. For example, the information processing apparatus 100 can provide information regarding an unnecessary (excessive) reward for achieving learning with higher accuracy.

### 1-5-6. Example of UI Screen According to Embodiment

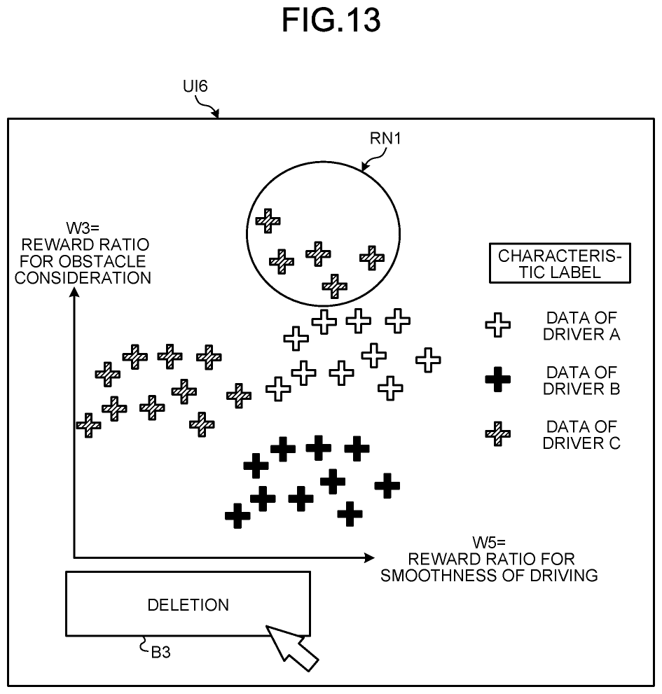

Next, an example of a UI screen according to the embodiment of the present disclosure will be described with reference to FIG. 13. FIG. 13 is a view illustrating an example of a UI screen according to the embodiment of the present disclosure.

Unlike FIG. 9, the display unit 156 in the example illustrated in FIG. 13 displays a UI button B3 that enables processing of deleting information indicating the weight of each of rewards. Specifically, the generation unit 155 generates a UI button that enables processing of deleting information indicating the weight of each of rewards selected by the user among the weights of each of rewards estimated by the estimation unit 154.

In the example illustrated in FIG. 13, the generation unit 155 generates the UI button B3 that enables statistical processing on the information indicating the weight of each of rewards selected by the user U1. Subsequently, the generation unit 155 generates content U16 including the generated UI button B3. After generating the content U16, the display unit 156 displays the generated content U16 on the output unit 130.

In addition, similarly to FIG. 9, FIG. 13 illustrates a state in which information (cross corresponding to “data of the driver C” illustrated in FIG. 13) indicating the weight of each of rewards estimated by the estimation unit 154 based on the training data group Cₖ (k is a natural number) including the driving data of the professional driver C is distributed separately in two clusters.

The user U1 selects, for example, the UI button B1 illustrated in FIG. 9, and performs statistical processing on information (hatched cross) indicating the weight of each of rewards estimated based on the training data group Cₖ (k is a natural number) including the driving data of the driver C. As a result of the statistical processing, the data included in the region surrounded by a circle RN1 in FIG. 13 has been found to be the driving data taken at the time of snowing.

Here, it is assumed that the learning data collected by the reinforcement learning unit 152 does not include driving data taken at the time of snowing. In this case, the machine learning model trained by using the reinforcement learning by the reinforcement learning unit 152 acquires a policy that does not consider snow at all. Therefore, even when the training data group received from the user U1 includes the driving data taken at the time of snowing, the estimation unit 154 cannot appropriately train the model to learn the driving operation adapted to the time of snowing. In addition, the driving data taken at the time of snowing would be a factor that lowers the accuracy of the machine learning model.

Therefore, the user U1 decides to delete the driving data taken at the time of snowing and retrain the machine learning model. Specifically, the user U1 selects data to be deleted and selects the UI button B3. The reception unit 151 receives a deletion operation for the information indicating the weight of the reward displayed by the display unit 156.

When the deletion operation has been received, the display unit 156 displays information regarding the weight of each of rewards estimated by retraining the machine learning model based on the training data corresponding to the information indicating the weight of the reward other than the information indicating the weight of the reward deleted by the deletion operation. Specifically, when the deletion operation has been received by the reception unit 151, retraining of the reward adjustment phase illustrated in FIG. 1 is performed. More specifically, when the reception unit 151 has received the deletion operation, the item of the reward ratio in the model information storage unit 143 is reset. Subsequently, with reference to the model information storage unit 143, the acquisition unit 153 acquires the machine learning model trained with the reinforcement learning by the reinforcement learning unit 152. Specifically, the acquisition unit 153 acquires model data MDT1 corresponding to most of the machine learning model trained with the reinforcement learning by the reinforcement learning unit 152.

In addition, the estimation unit 154 trains the machine learning model acquired by the acquisition unit 153 based on training data corresponding to information indicating a weight of a reward other than information indicating the weight of the reward deleted by the deletion operation. For example, having received the deletion operation, the reception unit 151 deletes the training data selected as a deletion target with reference to the training data storage unit 142. The training data storage unit 142 is updated by deletion of the training data by the reception unit 151. Subsequently, with reference to the updated training data storage unit 142, the estimation unit 154 trains the machine learning model acquired by the acquisition unit 153 based on the training data corresponding to the information indicating the weight of each of rewards after the update.

When there is a small amount of data groups having obviously different characteristics, the information processing apparatus 100 may directly judge the data as inappropriate and discard the data. Specifically, the generation unit 155 may independently delete data without receiving the selection operation of the UI button by the user U1.

### 1-5-7. Example of UI Screen According to Embodiment

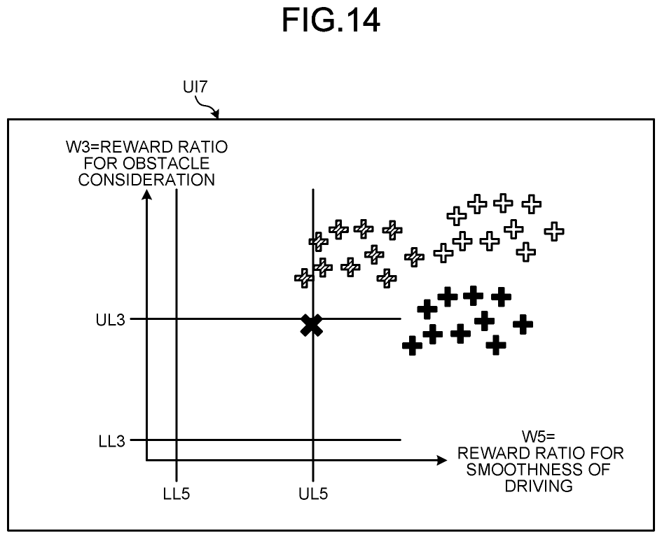

Next, an example of a UI screen according to the embodiment of the present disclosure will be described with reference to FIG. 14. FIG. 14 is a view illustrating an example of a UI screen according to the embodiment of the present disclosure. Compared to the graph illustrated in FIG. 8, FIG. 14 illustrates a UI screen in which information indicating the range of the weight w₃ of the reward R3 and the range of the weight w₅ of the reward R5 received from the user U1 is added to the graph illustrated in FIG. 8.

The display unit 156 displays information indicating a range of the weight of at least one of the weight ranges of each of rewards received by the reception unit 151. Specifically, with reference to the reward information storage unit 141, the generation unit 155 displays information indicating a range of the weight of at least one of the weight ranges of each of rewards. For example, with reference to the reward information storage unit 141, the generation unit 155 generates a graph displaying a straight line indicating a lower limit value and a straight line indicating an upper limit value of the weight of each of rewards.

In the example illustrated in FIG. 14, the display unit 156 displays information indicating a range of the weight w₃ of the reward R3. For example, the display unit 156 displays a straight line indicating a lower limit value LL3 and a straight line indicating an upper limit value UL3 of the weight w₃ of the reward R3 as the information indicating the range of the weight w₃ of the reward R3. With reference to the reward information storage unit 141, the generation unit 155 generates a graph displaying a straight line indicating the lower limit value LL3 of the weight w₃ of the reward R3 and a straight line indicating the upper limit value UL3 reward. Subsequently, the generation unit 155 generates content U17 including the generated graph. Subsequently, the display unit 156 displays the content U17 generated by the generation unit 155 on the output unit 130.

Furthermore, the display unit 156 displays information indicating a range of the weight w₅ of the reward R5. The display unit 156 displays a straight line indicating a lower limit value LL5 and a straight line indicating an upper limit value UL5 of the weight w₅ of the reward R5 as the information indicating the range of the weight w₅ of the reward R5. Specifically, with reference to the reward information storage unit 141, the generation unit 155 generates a graph displaying a straight line indicating the lower limit value LL5 of the weight w₅ of the reward R5 and a straight line indicating the upper limit value UL5. Subsequently, the generation unit 155 generates content U17 including the generated graph. Subsequently, the display unit 156 displays the content U17 generated by the generation unit 155 on the output unit 130.

With this configuration, for example, in a case where the range of the weight of each of rewards set by the user U1 and the information indicating the weight of each of rewards estimated by the information processing apparatus 100 are greatly different from each other, the information processing apparatus 100 can make the user U1 aware that the setting has been wrong.

### 1-5-8. Example of UI Screen According to Embodiment

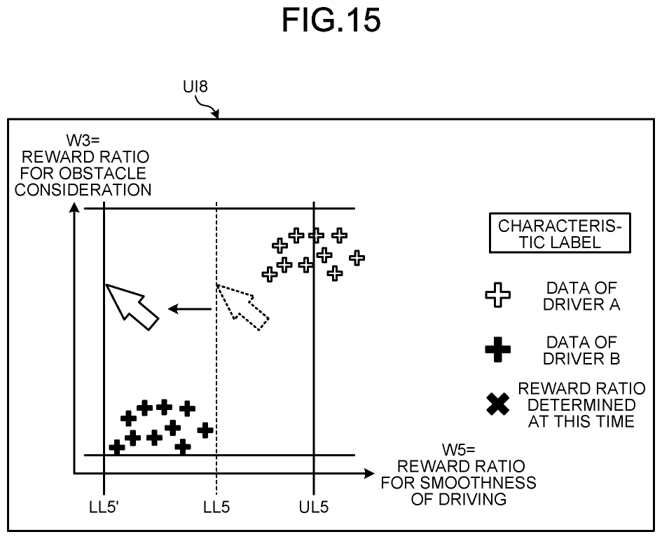

Next, an example of a UI screen according to the embodiment of the present disclosure will be described with reference to FIG. 15. FIG. 15 is a view illustrating an example of a UI screen according to the embodiment of the present disclosure. FIG. 15 illustrates an example of a UI screen indicating reception of a change operation of changing the range of the weight of each of rewards displayed by the display unit 156 as illustrated in FIG. 14, for example.

In the example illustrated in FIG. 15, the reception unit 151 receives an expanding operation of expanding the range of the weight w₅ of the reward R5 displayed by the display unit 156. Specifically, the reception unit 151 receives a change operation for changing the lower limit value LL5 of the weight w₅ of the reward R5 displayed by the display unit 156. More specifically, the reception unit 151 receives a change operation for changing the lower limit value LL5 of the weight w₅ of the reward R5 to a smaller lower limit value LL5′.

For example, the reception unit 151 receives a selection operation for a straight line indicating the lower limit value LL5 of the weight w₅ of the reward R5. Subsequently, the reception unit 151 receives a moving operation of moving the straight line selected by the selection operation to the origin side (to the side of reducing the value) along the axis of the weight w₅ of the reward R5. Subsequently, the reception unit 151 receives a stop operation of stopping the moving operation at a lower limit value LL5′ of the weight w₅ of the reward R5. When the reception unit 151 receives the stop operation, the generation unit 155 generates a graph displaying a straight line indicating the lower limit value LL5′ and a straight line indicating the upper limit value UL5 after the change of the weight w₅ of the reward R5. Subsequently, the generation unit 155 generates content U18 including the generated graph. Subsequently, the display unit 156 displays the content U18 generated by the generation unit 155 on the output unit 130. In this manner, the reception unit 151 receives a change operation for the information indicating the range of the weight of the reward displayed by the display unit 156. In addition, the display unit 156 displays information indicating the range of weights of the reward after the change, which has been received by the reception unit 151.

Furthermore, in a case where the change operation has been received, the display unit 156 displays information regarding the weight of each of rewards estimated by retraining the machine learning model based on the range of the weight of the reward after change, that is, the range of the weight of the reward changed by the change operation. Specifically, when a change operation has been received by the reception unit 151, the reinforcement learning unit 152 determines an input value of a weight of each of rewards based on a range of weight of each of rewards after the change by the change operation.

Subsequently, after having determined the input value of the weight of each of rewards, the reinforcement learning unit 152 collects learning data to be used for reinforcement learning. Subsequently, after collecting the learning data to be used for reinforcement learning, the reinforcement learning unit 152 uses reinforcement learning to train the machine learning model trained with reinforcement learning based on the plurality of rewards weighted by the input value of each of rewards.

The acquisition unit 153 acquires the machine learning model trained with the reinforcement learning by the reinforcement learning unit 152. In a case where the change operation has been received, the acquisition unit 153 acquires a machine learning model trained with reinforcement learning based on a plurality of rewards weighted by the weight of each of rewards based on the range of weights of the rewards after the change by the change operation. The estimation unit 154 estimates the weight of each of rewards by training the machine learning model in which the weight of each of rewards is defined as a part of the connection coefficient of the machine learning model such that, when the state information included in the training data and the value based on the weight of each of rewards are input, the model will output the action information included in the training data.

Subsequently, after estimating the weight of each of rewards, the display unit 156 displays information regarding the estimated weight of each of rewards.

### 1-5-9. Example of UI Screen According to Embodiment

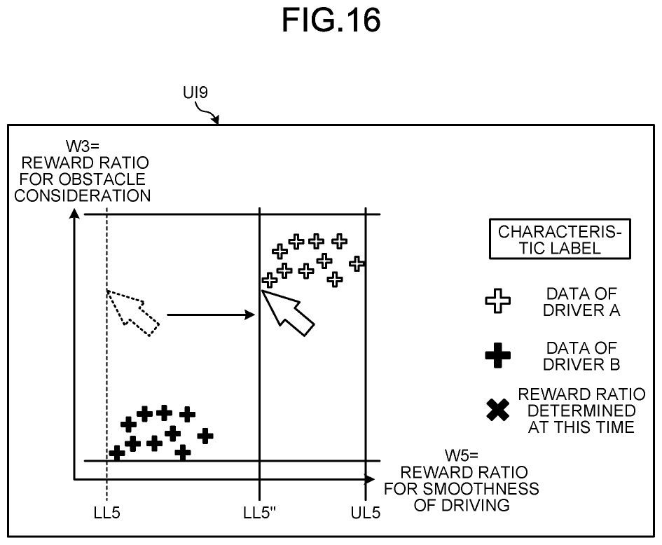

Next, an example of a UI screen according to the embodiment of the present disclosure will be described with reference to FIG. 16. FIG. 16 is a view illustrating an example of a UI screen according to the embodiment of the present disclosure. FIG. 16 illustrates an example of a UI screen indicating reception of a change operation of changing the range of the weight of each of rewards displayed by the display unit 156 as illustrated in FIG. 14, for example.

In the example illustrated in FIG. 16, the reception unit 151 receives a reduction operation of reducing the range of the weight w₅ of the reward R5 displayed by the display unit 156. Specifically, the reception unit 151 receives a change operation for changing the lower limit value LL5 of the weight w₅ of the reward R5 displayed by the display unit 156. More specifically, the reception unit 151 receives a change operation of changing the lower limit value LL5 of the weight w₅ of the reward R5 to a larger lower limit value LL5″.

For example, the reception unit 151 receives a selection operation for a straight line indicating the lower limit value LL5 of the weight w₅ of the reward R5. Subsequently, the reception unit 151 receives a moving operation of moving the straight line selected by the selection operation to the side opposite to the origin (to the side of increasing the value) along the axis of the weight w₅ of the reward R5. Subsequently, the reception unit 151 receives a stop operation of stopping the moving operation at the lower limit value LL5″ of the weight w₅ of the reward R5. When the reception unit 151 has received the stop operation, the generation unit 155 generates a graph displaying a straight line indicating the lower limit value LL5″ and a straight line indicating the upper limit value UL5 after the weight w₅ of the reward R5 is changed. Subsequently, the generation unit 155 generates content U19 including the generated graph. Subsequently, the display unit 156 displays the content U19 generated by the generation unit 155 on the output unit 130. In this manner, the reception unit 151 receives a change operation for the information indicating the range of the weight of the reward displayed by the display unit 156. In addition, the display unit 156 displays information indicating the range of weights of the reward after the change, which has been received by the reception unit 151.

### 1-5-10. Example of UI Screen According to Embodiment

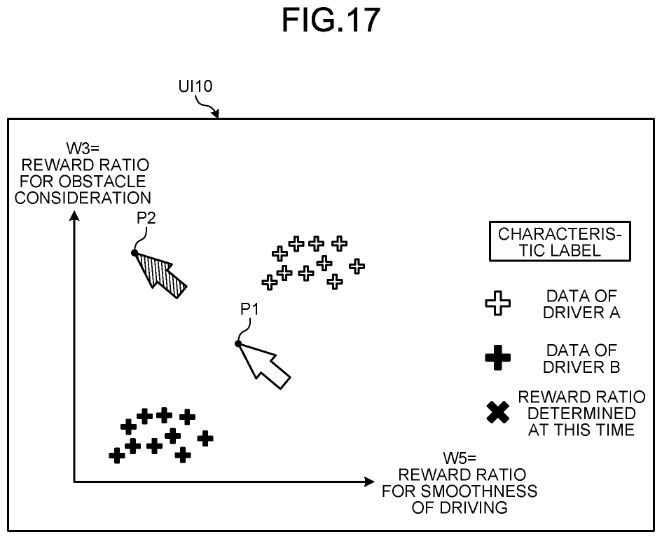

Next, an example of a UI screen according to the embodiment of the present disclosure will be described with reference to FIG. 17. FIG. 17 is a view illustrating an example of a UI screen according to the embodiment of the present disclosure. FIG. 17 illustrates an example of a UI screen that receives a designation operation of designating a value of a weight of each of rewards by receiving a designation operation for a point in a region of a graph displayed by the display unit 156.

In one example illustrated in FIG. 17, the reception unit 151 receives a designation operation for a point P1 located between a cluster corresponding to information indicating a weight of each of rewards estimated based on a training data group Aᵢ including driving data of a professional driver A and a cluster corresponding to information indicating a weight of each of rewards estimated based on a training data group Bⱼ (j is a natural number) including driving data of a professional driver B. In this manner, the reception unit 151 receives a designation operation for a point in the region of the graph displayed by the display unit 156.

Having received the designation operation for the point P1 by the reception unit 151, the generation unit 155 generates a graph displaying the designated point P1 with a black circle. Subsequently, the generation unit 155 generates content UI10 including the generated graph. Subsequently, the display unit 156 displays the content UI10 generated by the generation unit 155 on the output unit 130. In this manner, the reception unit 151 receives a designation operation for the weight of the reward displayed by the display unit 156. In addition, the display unit 156 displays information indicating the weight of the reward for which the designation by the reception unit 151 has been received.

When the designation operation has been received, the display unit 156 retrains the machine learning model based on the weight of the reward designated by the designation operation. Specifically, when the designation operation has been received by the reception unit 151, the reinforcement learning unit 152 determines the weight of each of rewards designated by the designation operation as an input value of the weight of each of rewards.

Subsequently, after having determined the input value of the weight of each of rewards, the reinforcement learning unit 152 collects learning data to be used for reinforcement learning. Subsequently, after collecting the learning data to be used for reinforcement learning, the reinforcement learning unit 152 uses reinforcement learning to train the machine learning model trained with reinforcement learning based on the plurality of rewards weighted by the input value of each of rewards.

The acquisition unit 153 acquires the machine learning model trained with the reinforcement learning by the reinforcement learning unit 152. When the designation operation has been received, the acquisition unit 153 acquires a machine learning model trained with reinforcement learning based on a plurality of rewards weighted by a weight of each of rewards based on a weight of a reward corresponding to a point designated by the designation operation.

With this configuration, in a case where the user U1 desires to train the model to learn a driving operation corresponding to an intermediate operation of the operations of the driver A and the driver B, the information processing apparatus 100 can design a machine learning model that performs a driving operation being an intermediate of operations of the driver A and the driver B by specifying the weight even when there is no corresponding driving data.

In addition, in another example illustrated in FIG. 17, the reception unit 151 receives a designation operation for a point P2 at which the reward ratio w₃ for obstacle consideration is located at the nearly same level as the information indicating the weight of each of rewards estimated based on the training data group Aᵢ including the driving data of the professional driver A, and at which the reward ratio w₅ for smoothness of driving is located at the nearly same level as the information indicating the weight of each of rewards estimated based on the training data group Bⱼ (j is a natural number) including the driving data of the professional driver B. In this manner, the reception unit 151 receives a designation operation for a point in the region of the graph displayed by the display unit 156.

With this configuration, in a case where the user U1 intends to train the model to learn a driving operation in which the degree of consideration for the obstacle is about the driver A and the degree of consideration for the smoothness of driving is about the driver B, even in a case where there is no corresponding driving data, the information processing apparatus 100 can train the machine learning model to perform a driving operation in which the degree of consideration for the obstacle is about the driver A and the degree of consideration for the smoothness of driving is about the driver B by specifying the weight.

In this manner, the information processing apparatus 100 receives designation of the weight of each of rewards by receiving the designation operation for a point in the region of the graph displayed by the display unit 156. With this configuration, even in a case where there is no training data corresponding to the designated weight, the information processing apparatus 100 can train a machine learning model to perform a driving operation corresponding to the designated weight by designating the weight.

### 1-5-11. Example of UI Screen According to Embodiment

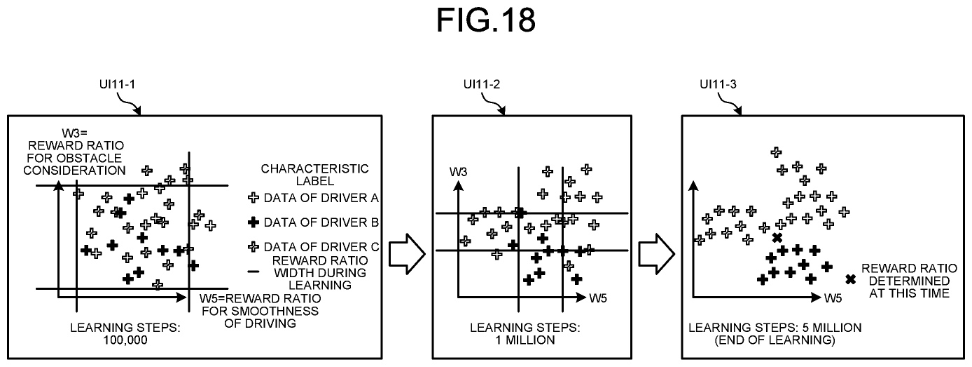

Next, an example of a UI screen according to the embodiment of the present disclosure will be described with reference to FIG. 18. FIG. 18 is a view illustrating an example of a UI screen according to the embodiment of the present disclosure. FIGS. 8 to 17 each illustrate an example in which the display unit 156 displays the estimation result regarding the weight of each of rewards obtained by the estimation unit 154. FIG. 18 will illustrate an example in which the display unit 156 displays information indicating the weight of each of rewards during learning (during estimation).

In the example illustrated in FIG. 18, the figure on the right side represents a state in which the learning is in a more advanced phase than the figure on the left side. Hereinafter, one repetition of the processing of steps S1 to S6 illustrated in FIG. 1 by the information processing apparatus 100 is counted as one learning step.

A diagram illustrated at the left end of FIG. 18 corresponds to a UI screen that displays information indicating the weight of each of rewards at the initial stage of learning (the number of learning steps is 100,000). A diagram illustrated in the center of FIG. 18 corresponds to a UI screen that displays information indicating the weight of each of rewards at a middle phase of learning (the number of learning steps is 1 million). Note that straight lines in the diagram illustrated at the left end of FIG. 18 and the diagram illustrated in the center of FIG. 18 indicate weight ranges (lower limit value and upper limit value) of each of rewards being estimated. Furthermore, a diagram illustrated at the right end of FIG. 18 corresponds to a UI screen that displays information indicating the weight of each of rewards after learning (after estimation).

As illustrated in FIG. 18, in a case where the learning is in normal progress, the range of the weight of each of rewards being estimated gradually narrows along with the progress of the learning. That is, as learning progresses, the value of the weight of each of rewards converges to a constant value.

In this manner, the display unit 156 displays information indicating the weight of each of rewards being estimated by the estimation unit 154. Specifically, the generation unit 155 generates a scatter plot representing information indicating the weight being estimated by the estimation unit 154. In addition, the generation unit 155 calculates a mean μ′ and a variance σ′ of the weights of the respective rewards under estimation based on the information indicating the weights under estimation by the estimation unit 154. Subsequently, the generation unit 155 calculates μ′±σ′ as a range of the weight of each of rewards being estimated based on the calculated mean μ′ and variance σ′ of the weights of each of rewards. Subsequently, the generation unit 155 generates a straight line indicating the calculated range of the weight of each of rewards under estimation. The generation unit 155 generates content UI11-1 to UI11-3 corresponding to the UI screen including the generated straight line and scatter plot. Subsequently, the display unit 156 displays the contents UI11-1 to UI11-3 generated by the generation unit 155 on the output unit 130.

The information processing apparatus 100 can allow the user U1 to visually recognize “the degree of progress of learning” and “normality of the progress of learning” by displaying the information indicating the weight of each of rewards being estimated.

### 1-5-12. Example of UI Screen According to Embodiment

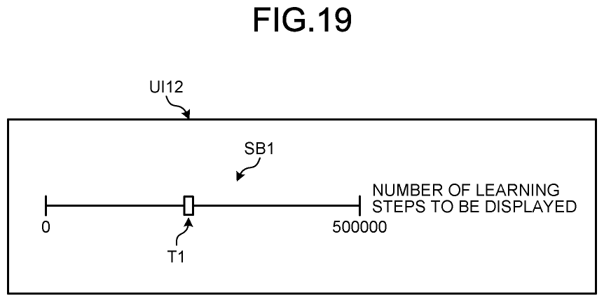

Next, an example of a UI screen according to the embodiment of the present disclosure will be described with reference to FIG. 19. FIG. 19 is a view illustrating an example of a UI screen according to the embodiment of the present disclosure. FIG. 19 illustrates a seek bar (slide bar) when the user selects the number of learning steps in FIG. 18.

Specifically, the generation unit 155 generates a seek bar SB1 including a slider T1 for selecting the number of learning steps. Having generated the seek bar SB1, the generation unit 155 generates content UI12 including the generated seek bar SB1. Subsequently, the display unit 156 displays the content UI12 generated by the generation unit 155 on the output unit 130.

In the example illustrated in FIG. 19, the reception unit 151 receives a selection operation for the slider T1 displayed by the display unit 156. The reception unit 151 receives the number of learning steps corresponding to the position of the slider T1 selected by the user U1. The display unit 156 displays information indicating the weight of each of rewards in the number of learning steps received by the reception unit 151.

### 1-5-13. Example of UI Screen According to Embodiment

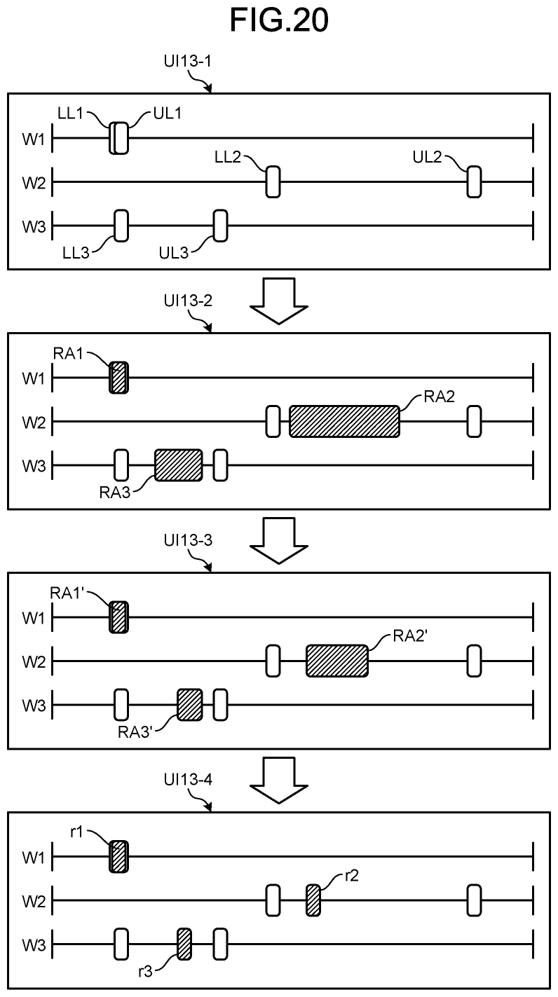

Next, an example of a UI screen according to the embodiment of the present disclosure will be described with reference to FIG. 20. FIG. 20 is a view illustrating an example of a UI screen according to the embodiment of the present disclosure. In the example illustrated in FIG. 20, the display unit 156 displays a one-dimensional graph with the weight wₙ (n=1 to 3) of each of rewards Rn (n=1 to 3) defined as an axis.

In the example illustrated in FIG. 20, the lower diagram represents a state in which the learning is in a more advanced phase than the upper diagram. The diagram illustrated at the top of FIG. 20 corresponds to a UI screen that displays information indicating the weight of each of rewards received by the reception unit 151. For example, the display unit 156 displays information indicating a lower limit value LLn (n=1 to 3) and an upper limit value ULn (n=1 to 3) of the weight wₙ (n=1 to 3) of each of rewards Rn (n=1 to 3) received by the reception unit 151 in a one-dimensional graph having the weight wₙ (n=1 to 3) of each of rewards Rn (n=1 to 3) defined as an axis.

Specifically, with reference to the reward information storage unit 141, the generation unit 155 generates content UI13-1 in which information indicating the lower limit value LLn (n=1 to 3) and the upper limit value ULn (n=1 to 3) of the weight wₙ (n=1 to 3) of each of rewards Rn (n=1 to 3) received by the reception unit 151 is displayed in a one-dimensional graph having the weight wₙ (n=1 to 3) of each of rewards Rn (n=1 to 3) defined as an axis. Subsequently, the display unit 156 displays the content UI13-1 generated by the generation unit 155 on the output unit 130. In this manner, the display unit 156 displays a graph having the weight of at least one reward among the weights of the respective rewards defined as an axis.

Furthermore, the second diagram from the top in FIG. 20 corresponds to a UI screen that displays information indicating the weight of each of rewards at a middle phase of learning. The display unit 156 displays information indicating a range of the weight of each of rewards being estimated by the estimation unit 154. Specifically, the generation unit 155 calculates a mean μ′ and a variance σ′ of the weights of the respective rewards under estimation based on the information indicating the weights under estimation by the estimation unit 154. Subsequently, the generation unit 155 calculates μ′±σ′ as a range of the weight of each of rewards being estimated based on the calculated mean μ′ and variance σ′ of the weights of each of rewards. The display unit 156 displays the range of the weight of each of rewards under estimation calculated by the generation unit 155 in a graph in a band shape.

In the second diagram from the top in FIG. 20, the display unit 156 displays a band RA1 indicating the range of the weight w₁ of the reward R1 being estimated by the estimation unit 154. In addition, the display unit 156 displays a band RA2 indicating a range of the weight w₂ of the reward R2 being estimated by the estimation unit 154. In addition, the display unit 156 displays a band RA3 indicating a range of the weight w₃ of the reward R3 being estimated by the estimation unit 154.

The third diagram from the top in FIG. 20 corresponds to a UI screen that displays information indicating the weight of each of rewards at a phase where the learning step proceeds more than the second diagram from the top in FIG. 20. The display unit 156 displays a band RA1′ indicating a range of the weight w₁ of the reward R1 being estimated by the estimation unit 154. In addition, the display unit 156 displays a band RA2′ indicating a range of the weight w₂ of the reward R2 being estimated by the estimation unit 154. In addition, the display unit 156 displays a band RA3′ indicating the range of the weight w₃ of the reward R3 being estimated by the estimation unit 154.

As illustrated in FIG. 20, in a case where the learning is in normal progress, the range of the weight of each of rewards being estimated gradually narrows along with the progress of the learning. That is, as learning progresses, the value of the weight of each of rewards converges to a constant value.

Furthermore, the fourth diagram from the top in FIG. 20 corresponds to a UI screen that displays information indicating the weight of each of rewards after learning (after estimation). Specifically, the generation unit 155 acquires the weight of the reward (reward ratio) estimated by the estimation unit 154. Subsequently, the display unit 156 displays the reward ratio acquired by the generation unit 155 on a graph.

The display unit 156 displays a reward ratio r1 on the graph, the reward ratio r1 being a weight of the reward R1 estimated by the estimation unit 154. In addition, the display unit 156 displays a reward ratio r2 estimated by the estimation unit 154 on the graph. In addition, the display unit 156 displays a reward ratio r3 of the reward R3 estimated by the estimation unit 154 on the graph.

Specifically, with reference to the item of the reward ratio in the model information storage unit 143, the generation unit 155 generates content UI13-4 in which information indicating the reward ratio rn (n=1 to 3), which is the weight of each of rewards Rn (n=1 to 3) estimated by the estimation unit 154, is displayed in a one-dimensional graph having the weight wₙ (n=1 to 3) of each of rewards Rn (n=1 to 3) defined as an axis. Subsequently, the display unit 156 displays the content UI13-4 generated by the generation unit 155 on the output unit 130.

### 1-5-14. Example of UI Screen According to Embodiment

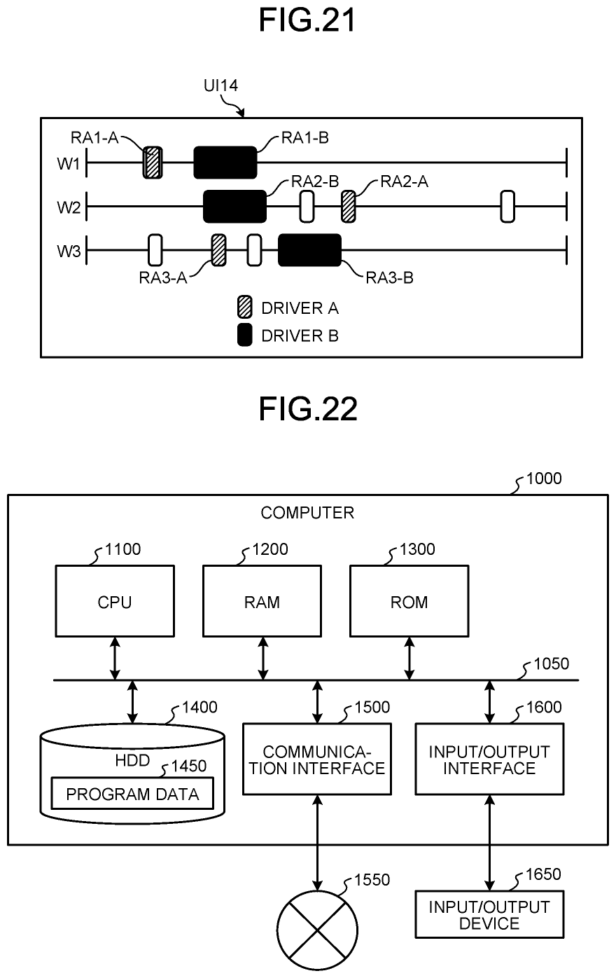

Next, an example of a UI screen according to the embodiment of the present disclosure will be described with reference to FIG. 21. FIG. 21 is a view illustrating an example of a UI screen according to the embodiment of the present disclosure. Unlike FIG. 20, the display unit 156 in the example illustrated in FIG. 21 displays information indicating the weight of each of rewards for each driver.

In the example illustrated in FIG. 21, the display unit 156 displays information indicating the weight wₙ (n=1 to 3) of each of rewards Rn (n=1 to 3) being estimated based on the training data group Aᵢ (i is a natural number) including the driving data of the professional driver A by the estimation unit 154 in a red band RAn-A (n=1 to 3). In FIG. 21, the information is displayed in black instead of red.

In addition, the display unit 156 displays information indicating the weight wₙ (n=1 to 3) of each of rewards Rn (n=1 to 3) being estimated based on the training data group Bⱼ (j is a natural number) including the driving data of the professional driver B by the estimation unit 154 in a blue band RAn-B (n=1 to 3). In FIG. 21, the information is displayed by hatching instead of blue.

Specifically, with reference to the item of the action subject in the training data storage unit 142, the generation unit 155 generates a one-dimensional graph displaying information indicating the weight of each of rewards being estimated by the estimation unit 154 in different colors for each action subject. Subsequently, the generation unit 155 generates content UI14 corresponding to the UI screen including the generated one-dimensional graph. Subsequently, the display unit 156 displays the content UI14 generated by the generation unit 155 on the output unit 130.

### 2. Other Embodiments

### 2-1. Display of Axes

Although the examples illustrated in FIGS. 8 to 21 each describe an example in which the display unit 156 displays the information indicating the weight of each of rewards by a two-dimensional or one-dimensional graph, the display unit 156 may display the information indicating the weight of each of rewards by using a three-dimensional graph. Specifically, with reference to the reward information storage unit 141, the generation unit 155 generates a graph with the weights of the three types of rewards selected from the weights wₙ (n=1 to 5) of the respective rewards Rn (n=1 to 5) defined as axes. Subsequently, the generation unit 155 generates content including the generated graph. Subsequently, the display unit 156 displays the content generated by the generation unit 155 on the output unit 130.

Furthermore, in a case where there is a weight of reward of (m+1) or more when the graph to be displayed is a m-dimensional (m=1 to 3) graph, the display unit 156 may select the weight of reward to be displayed as an axis of the graph either by user's selection or automatic selection. Specifically, the display unit 156 displays, on the screen, a list of weights of rewards to be displayed. For example, the display unit 156 selectively displays weights of a plurality of rewards to be displayed. The display unit 156 displays a graph with the weight of the reward selected by the user U1 as an axis from among the plurality of weights of the rewards displayed.

Alternatively, the generation unit 155 calculates a variance σ of the weights of the respective rewards. The display unit 156 may select and display the weight of the reward to be displayed as the axis of the graph based on the variance 6 calculated by the generation unit 155. Specifically, the display unit 156 selects the weight of the reward to be preferentially displayed as the axis of the graph in the order of the largest variance among the variances of the weights of the plurality of rewards calculated by the generation unit 155. For example, it is assumed, from the calculation performed by the generation unit 155 of the variance σ of the weights of the respective rewards, that the variance of the weight of the reward R1 is 0.23, the variance of the weight of the reward R2 is 2.25, the variance of the weight of the reward R3 is 0.08, the variance of the weight of the reward R4 is 0.11, and the variance of the weight of the reward R5 is 1.43. In this case, from among the variances of the weights of the five types of rewards calculated by the generation unit 155, the display unit 156 selects and displays the weight of the reward R2 having the largest variance and the weight of the reward R5 having the second largest variance as the weights of the rewards to be displayed as the axes of the graph.

Alternatively, the generation unit 155 generates a two-dimensional or three-dimensional axis based on principal component analysis regarding weights of a plurality of rewards. The display unit 156 displays a graph based on the axis generated by the generation unit 155.

### 2-2. Changing Reward

The reception unit 151 receives a change operation for the information regarding the reward displayed by the display unit 156. For example, the reception unit 151 receives a reselection operation for the reward selectively displayed by the display unit 156. Alternatively, the reception unit 151 may receive a change operation for the reward in a form of directly inputting the reward formula and the reward name from the user U1. When a change operation has been received by the reception unit 151, the reinforcement learning unit 152 uses reinforcement learning to train the machine learning model based on a plurality of rewards changed by the change operation. When a change operation has been received, the acquisition unit 153 acquires a machine learning model trained with reinforcement learning based on a plurality of rewards based on information regarding a reward changed by the change operation.

### 2-3. Clustering

As described with reference to FIG. 8, the information processing apparatus 100 enables clustering of the training data groups based on the characteristics of respective training data groups. Therefore, after the clustering of each training data group, the information processing apparatus 100 may divide the reinforcement learning to create a plurality of models. Specifically, with reference to the item of the action subject in the training data storage unit 142, the generation unit 155 clusters information indicating the weight of each of rewards estimated by the estimation unit 154 for each action subject. Based on the training data clustered for each action subject, the estimation unit 154 trains the machine learning model acquired by the acquisition unit 153 for each of clusters.

In the example illustrated in FIG. 8, with reference to the item of the action subject in the training data storage unit 142, the generation unit 155 generates a cluster CL11 of a training data group Aᵢ including the driving data of the professional driver A, a cluster CL21 of a training data group Bⱼ (j is a natural number) including the driving data of the professional driver B, and a cluster CL31 of a training data group Cₖ (k is a natural number) including the driving data of the professional driver C. Subsequently, the estimation unit 154 trains the machine learning model for each of the clusters. For example, the estimation unit 154 trains a machine learning model M11 that has learned the driving operation of the driver A based on the training data group Aᵢ included in the cluster CL11. In addition, the estimation unit 154 trains a machine learning model M21 that has learned the driving operation of the driver B based on the training data group Bi included in the cluster CL21. In addition, the estimation unit 154 trains a machine learning model M31 that has learned the driving operation of the driver C based on the training data group Ci included in the cluster CL31.

With this configuration, the information processing apparatus 100 can generate a machine learning model specialized for the driving operation of the driver who drives as desired by the designer.

### 2-4. Other Application Examples

The information processing apparatus 100 can be applied not only to autonomous driving of a vehicle but also to the automated driving of a drone and general motion control of a robot including operation control of articulated robots (industrial robots). For example, the information processing apparatus 100 uses training data of a professional racer or a professional drone pilot to generate a machine learning model (controller) that performs piloting similar to that of a professional racer or a professional drone pilot. Furthermore, for example, the information processing apparatus 100 generates a driver controller that performs safe driving based on training data of a driver with a spotless driving record.

Furthermore, the information processing apparatus 100 generates a machine learning model (controller) that performs operations of games such as Go, Shogi, or Chess, or a video game. For example, the information processing apparatus 100 generates a machine learning model that reproduces the strategy of a favorite player using a game record as training data. In addition, the information processing apparatus 100 generates a machine learning model that reproduces an intermediate or mixture of the strategies of favorite players A and B, using their game records as training data.

Furthermore, the information processing apparatus 100 is also applicable to an interactive agent. For example, by using an interaction sample of a favorite character as training data, the information processing apparatus 100 generates an agent that speaks in the same manner as the character. Furthermore, using conversational data of a highly moral person as training data, the information processing apparatus 100 generates an interactive agent that would not make a discriminative statement or a hate-speech. Incidentally, the information processing apparatus 100 cannot merely utilize human autonomous driving data, steering data, game data, conversation data, and the like as training data but also discriminate characteristics of training data used for the learning.

### 3. Effects According to Present Disclosure

As described above, the information processing apparatus 100 according to the present disclosure includes the acquisition unit 153, the reception unit 151, and the display unit 156. Based on the plurality of rewards weighted by the weight of each of rewards, the acquisition unit 153 acquires the machine learning model trained with reinforcement learning such that, when the first state information indicating the first state has been input, the model will output the first action information indicating the first action corresponding to the first state. The reception unit 151 receives training data that is a set of second state information indicating the second state and second action information indicating the second action corresponding to the second state. The display unit 156 displays information regarding the weight of each of rewards estimated by training the machine learning model in which the weight of each of rewards is defined as a part of the connection coefficient of the machine learning model such that, when second state information included in the training data and the value based on the weight of each of rewards have been input, the model will output second action information included in the training data.

With this configuration, the information processing apparatus 100 can support designing of the machine learning model trained with reinforcement learning so as to cause the robot to behave as intended by the designer. This makes it possible for the information processing apparatus 100 to support use of the machine learning model trained with the reinforcement learning.

Furthermore, the reception unit 151 receives a range of the weight of each of rewards. The acquisition unit 153 acquires a machine learning model trained with reinforcement learning based on a plurality of rewards weighted by the weights of the respective rewards falling within the weight ranges of the respective rewards received by the reception unit 151.

With this configuration, the information processing apparatus 100 can support designing of the machine learning model trained with reinforcement learning so that the robot behaves as intended by the designer within the range of the weight of each received reward.

Furthermore, the reception unit 151 receives information regarding a plurality of rewards. The acquisition unit 153 acquires a machine learning model trained with reinforcement learning based on a plurality of rewards based on information regarding the plurality of rewards received by the reception unit 151.

With this configuration, the information processing apparatus 100 can support designing of the machine learning model trained with reinforcement learning so that the robot behaves as intended by the designer based on the received reward.

Furthermore, the display unit 156 displays information indicating the weight of at least one reward among the weights of the respective rewards estimated based on the training data.

With this configuration, the information processing apparatus 100 can provide the user with information regarding the characteristics of each training data group used for estimation.

Furthermore, the training data includes subject information regarding the subject of the action of the second action information. The display unit 156 displays information indicating weights of rewards illustrated in different colors according to differences in subjects.

With this configuration, the information processing apparatus 100 can provide the user with information regarding the characteristic of each training data group for each action subject.

In addition, the display unit 156 displays statistical information regarding the weight of at least one reward among the weights of the respective rewards estimated based on the training data.

With this configuration, the information processing apparatus 100 can provide information necessary for achieving learning with higher accuracy. For example, the information processing apparatus 100 can provide information regarding a reward that needs to be considered in order to achieve learning with higher accuracy.

Furthermore, the display unit 156 displays a message related to the suggestion of retraining based on statistical information.

With this configuration, the information processing apparatus 100 can provide information necessary for achieving learning with higher accuracy. For example, the information processing apparatus 100 can provide information regarding a reward that needs to be considered in order to achieve learning with higher accuracy.

Furthermore, the training data includes environmental information regarding the environment in the second state. The statistical information is correlation information indicating a correlation between the weight of the reward and the environmental information, and the display unit 156 displays the correlation information. In addition, based on the correlation information, the display unit 156 displays a message related to a suggestion of retraining in consideration of a reward based on the environmental information.

With this configuration, the information processing apparatus 100 can provide information regarding the correlation between the weight of each of rewards estimated based on each training data group and each piece of environmental information included in each training data group, making it possible to provide information necessary for achieving learning with higher accuracy. For example, the information processing apparatus 100 can provide information regarding a reward necessary (lacking) for achieving learning with higher accuracy.

Furthermore, the statistical information is correlation information indicating a correlation between weights of at least any two rewards among weights of the respective rewards, and the display unit 156 displays the correlation information. In addition, the display unit 156 displays a message related to the suggestion of retraining in which at least one reward out of each of rewards has been deleted based on the correlation information.

With this configuration, the information processing apparatus 100 can provide information regarding the correlation between the weights of the respective rewards estimated based on the each of training data groups, and thus, can provide information necessary for achieving learning with higher accuracy. For example, the information processing apparatus 100 can provide information regarding an unnecessary (excessive) reward for achieving learning with higher accuracy.

Furthermore, the reception unit 151 receives a selection operation for the information indicating the weight of the reward displayed by the display unit 156. When the selection operation has been received, the display unit 156 displays information regarding training data corresponding to the information indicating the weight of the reward selected by the selection operation.

With this configuration, the information processing apparatus 100 enables the user to refer to the information regarding the training data based on the learning result.

In addition, the reception unit 151 receives a deletion operation for the information indicating the weight of the reward displayed by the display unit 156. When the deletion operation has been received, the display unit 156 displays information regarding the weight of each of rewards estimated by retraining the machine learning model based on the training data corresponding to the information indicating the weight of the reward other than the information indicating the weight of the reward deleted by the deletion operation.

With this configuration, the information processing apparatus 100 enables the user to change the training data based on the learning result. Furthermore, the information processing apparatus 100 enables retraining of the machine learning model based on the changed training data.

In addition, the display unit 156 displays a graph with the weight of at least one reward among the weights of the respective rewards defined as an axis. The reception unit 151 receives a designation operation for a point in the region of the graph displayed by the display unit 156. When the designation operation has been received, the acquisition unit 153 acquires a machine learning model trained with reinforcement learning based on a plurality of rewards weighted by a weight of each of rewards based on a weight of a reward corresponding to a point designated by the designation operation.

With this configuration, the information processing apparatus 100 enables the user to designate the weight of each of rewards based on the learning result. Furthermore, the information processing apparatus 100 enables retraining of the machine learning model based on the weight of each of rewards designated by the user.

Furthermore, the display unit 156 displays information indicating a range of the weight of at least one of the weight ranges of each of rewards received by the reception unit 151.

With this configuration, for example, in a case where the range of the weight of each of rewards set by the user and the information indicating the weight of each of rewards estimated by the information processing apparatus 100 are greatly different from each other, the information processing apparatus 100 can make the user aware that the setting has been wrong.

In addition, the reception unit 151 receives a change operation for information indicating a range of weight of the reward displayed by the display unit 156. In a case where the change operation has been received, the acquisition unit 153 acquires a machine learning model trained with reinforcement learning based on a plurality of rewards weighted by the weight of each of rewards based on the range of weights of the rewards after the change by the change operation.

With this configuration, the information processing apparatus 100 enables the user to change the range of the weight of each of rewards based on the learning result. Furthermore, the information processing apparatus 100 enables retraining of the machine learning model based on the range of the weight of each of rewards changed by the user.

Furthermore, the display unit 156 displays information regarding at least one reward among the pieces of information regarding the plurality of rewards received by the reception unit 151. In addition, the reception unit 151 receives a change operation for the information regarding the reward displayed by the display unit 156. When a change operation has been received, the acquisition unit 153 acquires a machine learning model trained with reinforcement learning based on a plurality of rewards based on information regarding a reward changed by the change operation.

With this configuration, the information processing apparatus 100 the information processing apparatus 100 enables the user to change the reward based on the learning result. Furthermore, the information processing apparatus 100 enables retraining of the machine learning model based on the reward changed by the user.

The effects described in the present specification are merely examples, and thus, there may be other effects, not limited to the exemplified effects.

### 4. Hardware Configuration

The information apparatus such as the information processing apparatus 100 according to the above-described embodiments and modifications are implemented by a computer 1000 having a configuration as illustrated in FIG. 22, for example. FIG. 22 is a hardware configuration diagram illustrating an example of the computer 1000 that implements the functions of the information processing apparatus such as the information processing apparatus 100. Hereinafter, the information processing apparatus 100 according to the embodiment will be described as an example. The computer 1000 includes a CPU 1100, RAM 1200, read only memory (ROM) 1300, a hard disk drive (HDD) 1400, a communication interface 1500, and an input/output interface 1600. Individual components of the computer 1000 are interconnected by a bus 1050.

The CPU 1100 operates based on a program stored in the ROM 1300 or the HDD 1400 so as to control each of components. For example, the CPU 1100 develops the program stored in the ROM 1300 or the HDD 1400 into the RAM 1200 and executes processes corresponding to various programs.

The ROM 1300 stores a boot program such as a basic input output system (BIOS) executed by the CPU 1100 when the computer 1000 starts up, a program dependent on hardware of the computer 1000, or the like.

The HDD 1400 is a non-transitory computer-readable recording medium that records a program executed by the CPU 1100, data used by the program, or the like. Specifically, the HDD 1400 is a recording medium that records an information processing program according to the present disclosure, which is an example of program data 1450.

The communication interface 1500 is an interface for connecting the computer 1000 to an external network 1550 (for example, the Internet). For example, the CPU 1100 receives data from other devices or transmits data generated by the CPU 1100 to other devices via the communication interface 1500.

The input/output interface 1600 is an interface for connecting an input/output device 1650 and the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. Furthermore, the input/output interface 1600 may function as a media interface for reading a program or the like recorded on predetermined recording medium (or simply medium). Examples of the media include optical recording media such as a digital versatile disc (DVD) or a phase change rewritable disk (PD), a magneto-optical recording medium such as a magneto-optical disk (MO), a tape medium, a magnetic recording medium, and semiconductor memory.

For example, when the computer 1000 functions as the information processing apparatus 100 according to the embodiment, the CPU 1100 of the computer 1000 executes the information processing program loaded on the RAM 1200 so as to implement the functions of the control unit 150 and the like. Furthermore, the HDD 1400 stores the information processing program according to the present disclosure or data in the storage unit 140. While the CPU 1100 executes program data 1450 read from the HDD 1400, the CPU 1100 may acquire these programs from another device via the external network 1550, as another example.

Note that the present technology can also have the following configurations.

(1)

An information processing apparatus comprising:
an acquisition unit that acquires a machine learning model trained with reinforcement learning such that, when first state information indicating a first state has been input, the model will output first action information indicating a first action corresponding to the first state, based on a plurality of rewards weighted by a weight of each of the rewards;
a reception unit that receives training data being a set of second state information indicating a second state and second action information indicating a second action corresponding to the second state; and
a display unit that displays information regarding the weight of each of the rewards estimated by training the machine learning model in which the weight of each of the rewards is defined as a part of a connection coefficient of the machine learning model such that, when the second state information included in the training data and a value based on the weight of each of the rewards have been input, the model will output the second action information included in the training data.
   (2)

The information processing apparatus according to (1),
wherein the reception unit receives a range of the weight of each of the rewards, and
the acquisition unit acquires the machine learning model trained with reinforcement learning based on the plurality of rewards weighted by the weight of each of the rewards falling within a range of the weight of each of the rewards received by the reception unit.
   (3)

The information processing apparatus according to (1) or (2),
wherein the reception unit receives information regarding the plurality of rewards, and
the acquisition unit acquires the machine learning model trained with reinforcement learning based on a plurality of rewards based on information regarding the plurality of rewards received by the reception unit.
   (4)

The information processing apparatus according to any of (1) to (3),
wherein the display unit displays information indicating the weight of at least one reward among the weights of each of the rewards estimated based on the training data.
   (5)

The information processing apparatus according to (4),
wherein the training data includes subject information regarding a subject of an action of the second action information, and
the display unit displays information indicating the weight of the reward illustrated in different colors according to a difference between the subjects.
   (6)

The information processing apparatus according to any of (1) to (5),
wherein the display unit displays statistical information regarding the weight of at least one reward among the weights of each of the rewards estimated based on the training data.
   (7)

The information processing apparatus according to (6),
wherein the display unit displays a message related to a suggestion of retraining based on the statistical information.
   (8)

The information processing apparatus according to (6) or (7),
wherein the training data includes environmental information regarding an environment in the second state,
the statistical information is correlation information indicating a correlation between the weight of the reward and the environmental information, and
the display unit displays the correlation information.
   (9)

The information processing apparatus according to (8),
wherein, based on the correlation information, the display unit displays a message related to a suggestion of retraining in consideration of a reward based on the environmental information.
   (10)

The information processing apparatus according to any of (6) to (9),
wherein the statistical information is correlation information indicating a correlation between weights of at least two rewards among the weights of each of the rewards, and
the display unit displays the correlation information.
   (11)

The information processing apparatus according to (10),
wherein the display unit displays a message related to a suggestion of retraining in which at least one reward out of each of the rewards is deleted based on the correlation information.
   (12)

The information processing apparatus according to any of (4) to (11),
wherein the reception unit receives a selection operation for information indicating the weight of the reward displayed by the display unit, and
when the selection operation has been received, the display unit displays information regarding the training data corresponding to information indicating the weight of the reward selected by the selection operation.
   (13)

The information processing apparatus according to any of (4) to (12),
wherein the reception unit receives a deletion operation for information indicating the weight of the reward displayed by the display unit, and
when the deletion operation has been received, the display unit displays information regarding a weight of each of the rewards estimated by retraining the machine learning model based on the training data corresponding to information indicating the weight of the reward other than information indicating a weight of a reward deleted by the deletion operation.
   (14)

The information processing apparatus according to any of (1) to (13),
wherein the display unit displays a graph with a weight of at least one reward among the weights of the respective rewards defined as an axis,
the reception unit receives a designation operation for a point in a region of the graph displayed by the display unit, and
when the designation operation has been received, the acquisition unit acquires the machine learning model trained with reinforcement learning based on a plurality of rewards weighted by a weight of each of rewards based on a weight of a reward corresponding to a point designated by the designation operation.
   (15)

The information processing apparatus according to any of (2) to (14),
wherein the display unit displays information indicating a range of the weight of at least one reward in the range of the weight of each of rewards received by the reception unit.
   (16)

The information processing apparatus according to (15),
wherein the reception unit receives a change operation for the information indicating the range of the weight of the reward displayed by the display unit, and
when the change operation has been received, the acquisition unit acquires the machine learning model trained with reinforcement learning based on the plurality of rewards weighted by the weight of each of the rewards based on a range of the weight of the reward changed by the change operation.
   (17)

The information processing apparatus according to any of (3) to (16),
wherein the display unit displays information regarding at least one reward out of pieces of information regarding a plurality of rewards received by the reception unit.
   (18)

The information processing apparatus according to (17),
wherein the reception unit receives a change operation for the information regarding the reward displayed by the display unit, and
when the change operation has been received, the acquisition unit acquires the machine learning model trained with reinforcement learning based on the plurality of rewards based on information regarding the reward changed by the change operation.
   (19)

An information processing apparatus comprising:
a reinforcement learning unit that trains a machine learning model with reinforcement learning such that, when first state information indicating a first state has been input, the model will output first action information indicating a first action corresponding to the first state, based on a plurality of rewards weighted by a weight of each of the rewards; and
an estimation unit that estimates the weight of each of the rewards by training the machine learning model in which a weight of each of the rewards is defined as a part of a connection coefficient of the machine learning model such that, when second state information indicating a second state included in the training data being a set of the second state information and second action information indicating a second action corresponding to the second state, and a value based on the weight of each of the rewards, have been input, the model will output the second action information included in the training data.
   (20)

An information processing method comprising:
acquiring a machine learning model trained with reinforcement learning such that, when first state information indicating a first state has been input, the model will output first action information indicating a first action corresponding to the first state, based on a plurality of rewards weighted by a weight of each of the rewards;
receiving training data being a set of second state information indicating a second state and second action information indicating a second action corresponding to the second state; and
displaying information regarding the weight of each of the rewards estimated by training the machine learning model in which the weight of each of the rewards is defined as a part of a connection coefficient of the machine learning model such that, when the second state information included in the training data and a value based on the weight of each of the rewards have been input, the model will output the second action information included in the training data.

### REFERENCE SIGNS LIST

1 INFORMATION PROCESSING SYSTEM
100 INFORMATION PROCESSING APPARATUS
110 COMMUNICATION UNIT
120 INPUT UNIT
130 OUTPUT UNIT
140 STORAGE UNIT
141 REWARD INFORMATION STORAGE UNIT
142 TRAINING DATA STORAGE UNIT
143 MODEL INFORMATION STORAGE UNIT
150 CONTROL UNIT
151 RECEPTION UNIT
152 REINFORCEMENT LEARNING UNIT
153 ACQUISITION UNIT
154 ESTIMATION UNIT
155 GENERATION UNIT
156 DISPLAY UNIT

1. An information processing apparatus comprising:
an acquisition unit that acquires a machine learning model trained with reinforcement learning such that, when first state information indicating a first state has been input, the model will output first action information indicating a first action corresponding to the first state, based on a plurality of rewards weighted by a weight of each of the rewards;
a reception unit that receives training data being a set of second state information indicating a second state and second action information indicating a second action corresponding to the second state; and
a display unit that displays information regarding the weight of each of the rewards estimated by training the machine learning model in which the weight of each of the rewards is defined as a part of a connection coefficient of the machine learning model such that, when the second state information included in the training data and a value based on the weight of each of the rewards have been input, the model will output the second action information included in the training data.

2. The information processing apparatus according to claim 1,
wherein the reception unit receives a range of the weight of each of the rewards, and
the acquisition unit acquires the machine learning model trained with reinforcement learning based on the plurality of rewards weighted by the weight of each of the rewards falling within a range of the weight of each of the rewards received by the reception unit.

3. The information processing apparatus according to claim 1,
wherein the reception unit receives information regarding the plurality of rewards, and
the acquisition unit acquires the machine learning model trained with reinforcement learning based on a plurality of rewards based on information regarding the plurality of rewards received by the reception unit.

4. The information processing apparatus according to claim 1,
wherein the display unit displays information indicating the weight of at least one reward among the weights of each of the rewards estimated based on the training data.

5. The information processing apparatus according to claim 4,
wherein the training data includes subject information regarding a subject of an action of the second action information, and
the display unit displays information indicating the weight of the reward illustrated in different colors according to a difference between the subjects.

6. The information processing apparatus according to claim 1,
wherein the display unit displays statistical information regarding the weight of at least one reward among the weights of each of the rewards estimated based on the training data.

7. The information processing apparatus according to claim 6,
wherein the display unit displays a message related to a suggestion of retraining based on the statistical information.

8. The information processing apparatus according to claim 6,
wherein the training data includes environmental information regarding an environment in the second state,
the statistical information is correlation information indicating a correlation between the weight of the reward and the environmental information, and
the display unit displays the correlation information.

9. The information processing apparatus according to claim 8,
wherein, based on the correlation information, the display unit displays a message related to a suggestion of retraining in consideration of a reward based on the environmental information.

10. The information processing apparatus according to claim 6,
wherein the statistical information is correlation information indicating a correlation between weights of at least two rewards among the weights of each of the rewards, and
the display unit displays the correlation information.

11. The information processing apparatus according to claim 10,
wherein the display unit displays a message related to a suggestion of retraining in which at least one reward out of each of the rewards is deleted based on the correlation information.

12. The information processing apparatus according to claim 4,
wherein the reception unit receives a selection operation for information indicating the weight of the reward displayed by the display unit, and
when the selection operation has been received, the display unit displays information regarding the training data corresponding to information indicating the weight of the reward selected by the selection operation.

13. The information processing apparatus according to claim 4,
wherein the reception unit receives a deletion operation for information indicating the weight of the reward displayed by the display unit, and
when the deletion operation has been received, the display unit displays information regarding a weight of each of the rewards estimated by retraining the machine learning model based on the training data corresponding to information indicating the weight of the reward other than information indicating a weight of a reward deleted by the deletion operation.

14. The information processing apparatus according to claim 1,
wherein the display unit displays a graph with a weight of at least one reward among the weights of the respective rewards defined as an axis,
the reception unit receives a designation operation for a point in a region of the graph displayed by the display unit, and
when the designation operation has been received, the acquisition unit acquires the machine learning model trained with reinforcement learning based on a plurality of rewards weighted by a weight of each of rewards based on a weight of a reward corresponding to a point designated by the designation operation.

15. The information processing apparatus according to claim 2,
wherein the display unit displays information indicating a range of the weight of at least one reward in the range of the weight of each of rewards received by the reception unit.

16. The information processing apparatus according to claim 15,
wherein the reception unit receives a change operation for the information indicating the range of the weight of the reward displayed by the display unit, and
when the change operation has been received, the acquisition unit acquires the machine learning model trained with reinforcement learning based on the plurality of rewards weighted by the weight of each of the rewards based on a range of the weight of the reward changed by the change operation.

17. The information processing apparatus according to claim 3,
wherein the display unit displays information regarding at least one reward out of pieces of information regarding a plurality of rewards received by the reception unit.

18. The information processing apparatus according to claim 17,
wherein the reception unit receives a change operation for the information regarding the reward displayed by the display unit, and
when the change operation has been received, the acquisition unit acquires the machine learning model trained with reinforcement learning based on the plurality of rewards based on information regarding the reward changed by the change operation.

19. An information processing apparatus comprising:
a reinforcement learning unit that trains a machine learning model with reinforcement learning such that, when first state information indicating a first state has been input, the model will output first action information indicating a first action corresponding to the first state, based on a plurality of rewards weighted by a weight of each of the rewards; and
an estimation unit that estimates the weight of each of the rewards by training the machine learning model in which a weight of each of the rewards is defined as a part of a connection coefficient of the machine learning model such that, when second state information indicating a second state included in the training data being a set of the second state information and second action information indicating a second action corresponding to the second state, and a value based on the weight of each of the rewards, have been input, the model will output the second action information included in the training data.

20. An information processing method comprising:
acquiring a machine learning model trained with reinforcement learning such that, when first state information indicating a first state has been input, the model will output first action information indicating a first action corresponding to the first state, based on a plurality of rewards weighted by a weight of each of the rewards;
receiving training data being a set of second state information indicating a second state and second action information indicating a second action corresponding to the second state; and
displaying information regarding the weight of each of the rewards estimated by training the machine learning model in which the weight of each of the rewards is defined as a part of a connection coefficient of the machine learning model such that, when the second state information included in the training data and a value based on the weight of each of the rewards have been input, the model will output the second action information included in the training data.
